(19) United States
(12) Patent Application Publication
(10) Pub. No.: US 2022/0003357 A1
(43) Pub. Date: Jan. 6, 2022

(54) CONNECTION ASSEMBLY AND GIMBAL DEVICE

(71) Applicant: SZ DJI TECHNOLOGY CO., LTD., Shenzhen (CN)

(72) Inventors: Yanchen LIU, Shenzhen (CN); Shimeng BEI, Shenzhen (CN); Paul PAN, Shenzhen (CN); Weizhong XUE, Shenzhen (CN)

(21) Appl. No.: 17/481,735

(22) Filed: Sep. 22, 2021

Related U.S. Application Data
(63) Continuation of application No. PCT/CN2019/079383, filed on Mar. 22, 2019.

(51) Int. Cl. F16M 11/18; F16M 13/04; G03B 17/56

(52) U.S. Cl. CPC F16M 11/18; G03B 17/561; F16M 13/04

(57) ABSTRACT

A connection assembly includes two connection members configured to be detachably connected to each other. At least one of the two connection members is configured to be connected to a gimbal. The two connection members are configured to be connected to each other in one of a plurality of connection modes to support a plurality of usage modes of the gimbal and/or adapt to a plurality of usage attitudes of the gimbal.

### CROSS-REFERENCE TO RELATED APPLICATION

This application is a continuation of International Application No. PCT/CN2019/079383, filed Mar. 22, 2019, the entire content of which is incorporated herein by reference.

### TECHNICAL FIELD

The present disclosure relates to the technical field of gimbal device and, more particularly, to a connection assembly and a gimbal device.

### BACKGROUND

A gimbal, such as a handheld gimbal, uses an electronic acceleration meter and a gyro sensor to sense angle and motion of a camera, and is directly driven by at least one of a pitch motor, a roll motor, or a yaw motor to achieve a stabilization with real-time correction. Because of its portability, ease of use, and good stability, the gimbal has been widely applied. However, current gimbal structure only has a single-handed usage attitude, and application scenario is relatively single.

### SUMMARY

In accordance with the disclosure, there is provided a connection assembly including two connection members configured to be detachably connected to each other. At least one of the two connection members is configured to be connected to a gimbal. The two connection members are configured to be connected to each other in one of a plurality of connection modes to support a plurality of usage modes of the gimbal and/or adapt to a plurality of usage attitudes of the gimbal

Also in accordance with the disclosure, there is provided a gimbal device including a gimbal and a connection assembly. The connection assembly includes two connection members configured to be detachably connected to each other. At least one of the two connection members is configured to be connected to the gimbal. The two connection members are configured to be connected to each other in one of a plurality of connection modes to support a plurality of usage modes of the gimbal and/or adapt to a plurality of usage attitudes of the gimbal.

### BRIEF DESCRIPTION OF THE DRAWINGS

The above and/or additional aspects and advantages of the present disclosure will become obvious and easy to understand from the description of the embodiments in conjunction with the following drawings.

FIG. 1 is a perspective view of a connection assembly connected to a gimbal according to an embodiment of the present disclosure.

FIG. 2 is a perspective view of a middle frame of a connection assembly according to an embodiment of the present disclosure.

FIGS. 3 and 4 are schematic diagrams of a support member of a connection assembly according to an embodiment of the present disclosure.

FIG. 5 is an schematic exploded view of a support member of a connection assembly according to an embodiment of the present disclosure.

FIG. 6 is a schematic diagram of a support member of a connection assembly according to another embodiment of the present disclosure.

FIG. 7 is an schematic exploded view of a support member of a connection assembly according to another embodiment of the present disclosure.

FIGS. 8-17 are schematic diagrams of connection modes of a connection assembly according to an embodiment of the present disclosure.

FIGS. 18-26 are schematic diagrams of a connection assembly connected to a gimbal according to an embodiment of the present disclosure.

### DETAILED DESCRIPTION OF THE EMBODIMENTS

The embodiments of the present disclosure are described in detail below. Examples of the embodiments are shown in the accompanying drawings, where the same or similar reference numerals indicate the same or similar elements or elements with the same or similar functions. The following embodiments described with reference to the accompanying drawings are exemplary, and are only used to explain the present disclosure, and should not be understood as a limitation to the present disclosure.

In the description of the present disclosure, it should be understood that the terms “center,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” and other directions or positional relationships are based on the orientation or positional relationship shown in the drawings, are only for the convenience of describing the application and simplifying the description, and do not indicate or imply that the device or element referred to must have a specific orientation, be constructed, and operated in a specific orientation. Therefore, they cannot be understood as a restriction on the present disclosure. In addition, the terms “first” and “second” are only used for descriptive purposes, and should not be understood as indicating or implying relative importance or implicitly indicating the number of indicated technical features. Therefore, the features defined with “first” and “second” may explicitly or implicitly include one or more of the features. In the description of the present disclosure, “multiple” or “plurality of” means two or more than two, unless otherwise specifically defined.

In the description of the present disclosure, it should be noted that the terms “mounting,” “connection,” and “coupling” should be interpreted broadly unless otherwise clearly specified and limited. For example, it can be a fixed connection, a detachable connection, or an integrated connection. It can be a mechanical connection or an electrical connection. It can be direct connection, or indirect connection through an intermediate medium, and it can be a communication between two elements or an interaction relationship between two elements. For those of ordinary skill in the art, the specific meanings of the above terms in the present disclosure can be understood according to specific circumstances.

The following disclosure provides many different embodiments or examples to realize different structures of the present disclosure. In order to simplify the disclosure of the present disclosure, components and settings of the examples are described below. Of course, they are only examples and are not intended to limit the present disclosure. In addition, the present disclosure may repeat reference numerals and/or reference letters in different examples. Such repetition is for the purpose of simplification and clarity, and does not indicate the relationship between the various embodiments and/or settings discussed. In addition, the present disclosure provides examples of various processes and materials, but those of ordinary skill in the art may be aware of the application of other processes and/or the use of other materials.

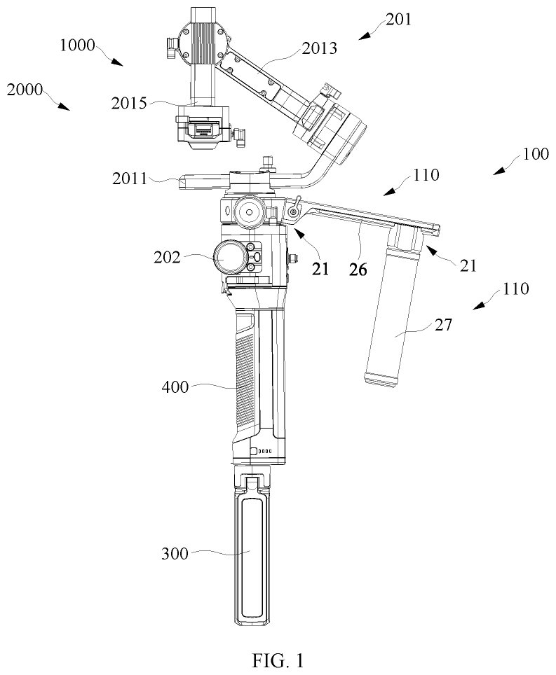

Referring to FIG. 1, in some embodiments of the present disclosure, a connection assembly 100 can be applied to a gimbal 1000, and the connection assembly 100 includes at least two connection members 110. At least one connection member 110 is connected to the gimbal 1000, and any two of the at least two connection members 110 can be detachably connected to each other. There are multiple connection modes among the at least two connection members 110 to support multiple usage modes of the gimbal 1000 and/or adapt to multiple usage attitudes of the gimbal 1000.

In some embodiments of the present disclosure, any two connection members 110 in the connection assembly 100 can be detachably connected to each other, and there are multiple connection modes between the two connection members 110 to support the multiple usage modes of the gimbal 1000 and/or adapt to the multiple usage attitudes of the gimbal 1000, which is beneficial to adapt to different shooting environments and provide assistance for shooting effect required by an user, so that application scenarios are diversified.

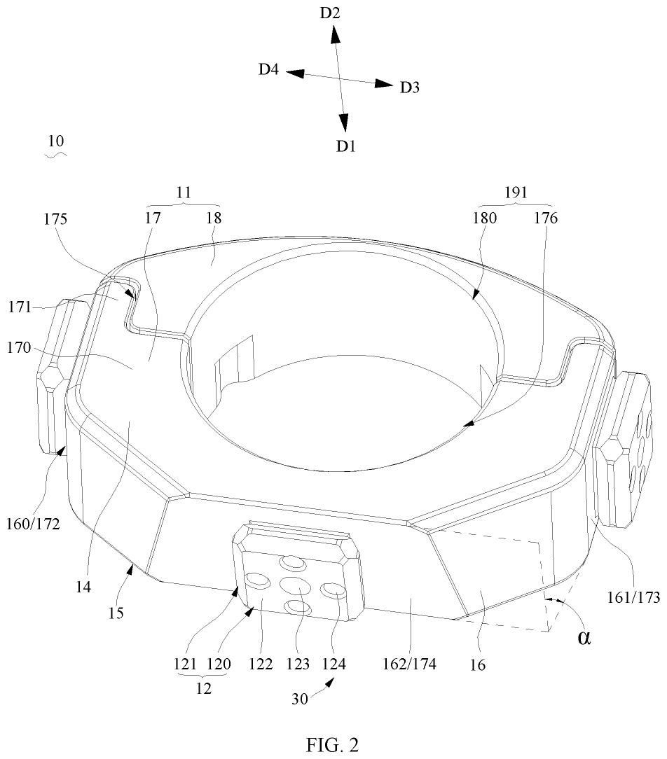

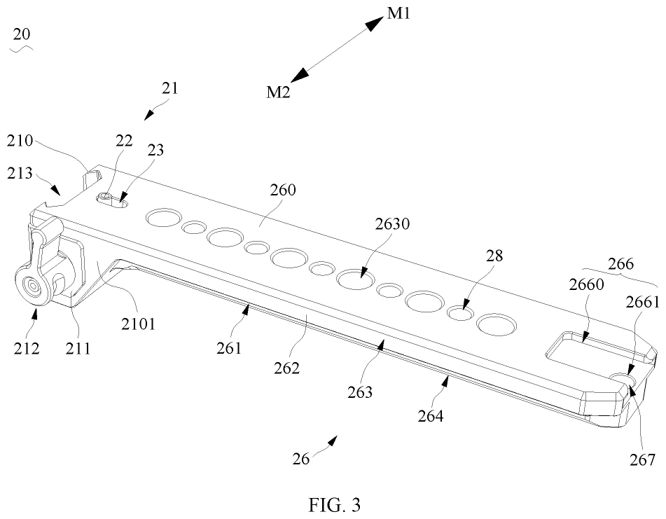

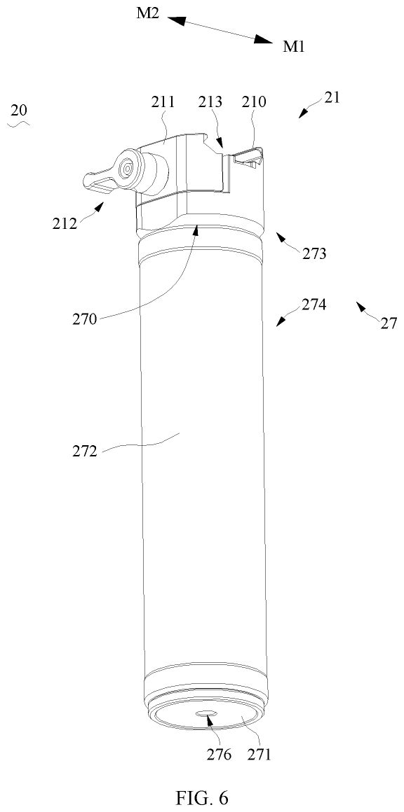

Referring to FIGS. 1 and 2, in some embodiments of the present disclosure, the connection assembly 100 can be applied to the gimbal 1000, and the connection assembly 100 includes a middle frame 10 that can be configured to connect with the gimbal 1000. The middle frame 10 includes a frame 11 and a base 12, and the base 12 is fixed at a frame side surface 16 of the frame 11. The base 12 is configured to be connected to an element to be mounted (such as a side plate 26 shown in FIG. 3 and/or a handle 27 shown in FIG. 6), and the element to be mounted can be detachably mounted at the base 12 from at least two directions.

In some embodiments of the present disclosure, the connection assembly 100 is provided with the base 12 having multiple mounting directions, so that the element to be mounted can be mounted at the base 12 from different mounting directions according to actual conditions, which improves adaptability of the base 12 and the element to be mounted. Therefore, the middle frame 10 and the element to be mounted can be combined into multiple usage attitudes, and usage scenarios of the connection assembly 100 can be enriched, so that the connection assembly 100 can be connected to the gimbal 1000 to form multiple usage modes and/or usage attitudes, which is conducive to diversification of the application scenarios.

Referring to FIGS. 1, 5, and 7, in some embodiments of the present disclosure, the connection assembly 100 can be applied to the gimbal 1000, and the connection assembly 100 includes a support member 20. The support member 20 is provided with a mounting member 21, and the support member 20 is connected to the gimbal 1000 through the mounting member 21. The mounting member 21 includes a fixed base 210 and a movable member 211, and the fixed base 210 cooperates with the movable member 211 to form an accommodation groove 213. Relative positions of the movable member 211 and the fixed base 210 can be changed to change size of the accommodation groove 213. When the movable member 211 is close to the fixed base 210, the size of the accommodation groove 213 is reduced, and the support member 20 can be fixed at the gimbal 1000. When the movable member 211 is away from the fixed base 210, the size of the accommodation groove 213 is increased, and the support member 20 can be separated from the gimbal 1000 or slide at the gimbal 1000.

In some embodiments of the present disclosure, the connection assembly 100 is provided with the support member 20 that can change the size of the accommodation groove 213, so that after the support member 20 is mounted at the gimbal 1000, the user can fix the support member 20 at the gimbal 1000 by reducing the size of the accommodation groove 213, and when the support member 20 and the gimbal 1000 need to be disassembled, the user can detach the support member 20 from the gimbal 1000 by increasing the size of the accommodation groove 213. As such, the support member 20 is simple in structure, and an operation of adjusting the size of the accommodation groove 213 is convenient, which are beneficial to reduce complexity of connection between the support member 20 and the gimbal 1000, and improve assembly and disassembly efficiency of the user. In addition, the accommodation grooves 213 of different sizes increase selection of connection positions of the connection assembly 100 and the gimbal 1000, and the user can connect the connection assembly 100 to different positions at the gimbal 1000 according to actual shooting needs to be connected to the gimbal 1000 into multiple usage attitudes, so that the application scenarios of the connection assembly 100 are diversified.

Referring to FIG. 1, in some embodiments of the present disclosure, a gimbal device 2000 includes the gimbal 1000 and the connection assembly 100, and the gimbal 1000 is connected to the connection assembly 100. The connection assembly 100 can be the connection assembly 100 of any embodiment of the present disclosure. As such, the connection assembly 100 can support the multiple usage modes of the gimbal 1000 and/or adapt to the multiple usage attitudes of the gimbal 1000, which is beneficial to adapt to different shooting environments and provide assistance for the shooting effect required by the user, so that the application scenarios are diversified.

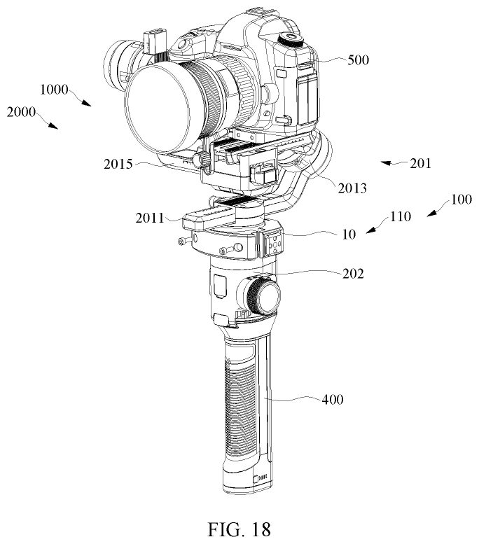

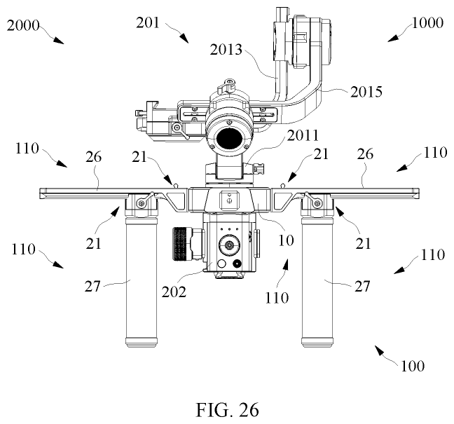

Referring to FIG. 1, the connection assembly 100 of the present disclosure can be used in conjunction with the gimbal 1000, and can be used together for photographing such as filming, entertainment, selfie, etc. The gimbal 1000 can be a single-axis gimbal, a two-axis gimbal, a three-axis gimbal, or even a multi-axis gimbal. For better description, the gimbal 1000 is illustrated herein as an example of a three-axis gimbal. Specifically, the gimbal 1000 can include a frame 201 and an operation member 202. The frame 201 can include an outer frame 2011, a middle frame 2013, and an inner frame 2015, where the outer frame 2011 can be connected to a yaw motor, the middle frame 2013 can be connected to a roll motor, and the inner frame 2015 can be connected to a pitch motor. The outer frame 2011, the middle frame 2013, and the inner frame 2015 are connected in sequence and can all rotate relative to each other, and rotation axes of the three are non-orthogonal (can all be perpendicular to each other in some other embodiments). The operation member 202 can be connected to the outer frame 2011, and the outer frame 2011 can rotate relative to the operation member 202. The operation member 202 is provided with control buttons (which can be physical buttons or virtual buttons), and the user can manipulate the frame 201 through the control buttons at the operation member 202, and adjust shooting parameters of a photographing apparatus 500 (shown in FIG. 18) mounted at the gimbal 1000. In some other embodiments, the gimbal 1000 may also be provided with a grip 400 and a bracket 300, and the grip 400 may be connected to the operation member 202. A power supply may be provided within the grip 400 so as to supply power to the operation member 202 and the frame 201. The bracket 300 may be mounted at the bottom of the grip 400, and the bracket 300 may be a tripod. The grip 400 and the operation member 202 may be a fixed and undetachable connection, or a detachable connection. The bracket 300 and the grip 400 may be a fixed and undetachable connection, or a detachable connection. In some other embodiments, the gimbal 1000 may not be provided with the grip 400 and the bracket 300 (shown in FIG. 26), in which case the connection assembly 100 and the gimbal 1000 can be used for handheld shooting by the user, or the connection assembly 100 and the gimbal 1000 can be mounted at another platform, such as a car or a flight platform.

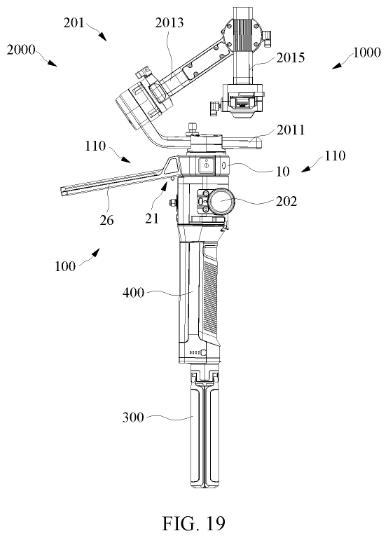

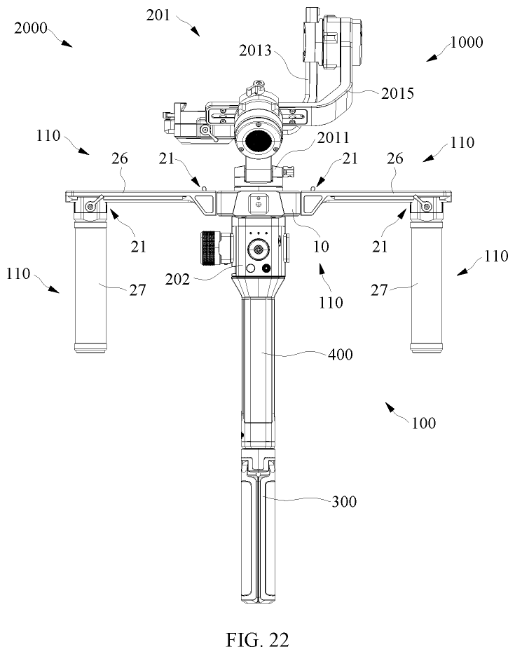

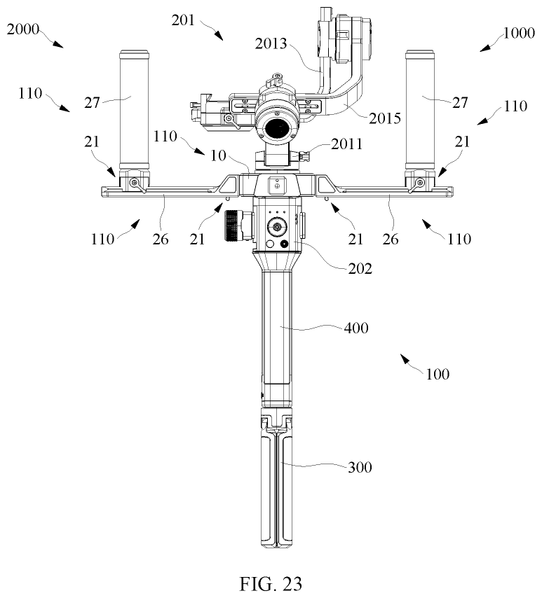

The connection assembly 100 can be connected to the operation member 202. The connection assembly 100 includes a plurality of connection members 110, and different connection members 110 can be connected to each other (that is, adjusting connection position and connection direction among the connection members 110) to form a variety of different connection modes (as can be seen in connection modes between the connection assembly 100 and the gimbal 1000 in FIGS. 19-26), which can support the multiple usage modes of the gimbal 1000 and adapt to the multiple usage attitudes of the gimbal 1000. The usage mode and the usage attitude of the gimbal 1000 can be understood such as the user correspondingly moving the gimbal 1000 in order to achieve desired shooting mode (such as pushing, pulling, panning, shifting, etc. of a lens), so as to provide various assistance for the photographing apparatus 500. The corresponding movement can be a change in the position of the gimbal 1000 in a horizontal direction and a change in a tilt angle of the gimbal 1000 relative to the horizontal direction, or a change in the position of the gimbal 1000 in vertical direction and a change in a tilt angle of the gimbal 1000 relative to the vertical direction. For example, the connection assembly 100 and the gimbal 1000 can be combined into an attitude of usage mode such as a portable suspension mode, an upside-down mode, a hand-held mode, etc. The portable suspension mode can be used as a low-position suspension condition of the gimbal 1000, and the user can hold the connection assembly 100 and the gimbal 1000 close to ground or directly hold in front of body to obtain a smooth and stable picture, as can be seen in a combination mode in FIG. 23. With the portable suspension mode, the connection assembly 100 and the gimbal 1000 can also be mounted at the flight platform, such as the combination mode in FIG. 23 where the grip 400 and the bracket 300 are detached and then the connection assembly 100 and the gimbal 1000 are mounted at the flight platform. The upside-down mode can be used as a high-position shooting of the gimbal 1000, and the user can place the gimbal 1000 in the car or another relatively high position for shooting. With the upside-down operation mode, the user can easily turn the gimbal 1000 up and down without laboriously lifting the gimbal 1000 to keep a camera and eyes on the same level, and the upside-down operation mode can be realized by flipping 180 degrees from the portable suspension mode. In the upside-down mode, shooting angle of the photographing apparatus can be made higher, as can be seen in a combination mode in FIG. 22. The hand-held mode may be suitable for the gimbal 1000 to shot following steps of the user, and is suitable for near-ground mobile shooting in a narrow space. It is difficult for any part of the gimbal 1000 to contact the body of the user (especially legs), so that the gimbal 1000 can be completely prevented from being obstructed by its own body or another object when working in a narrow space. In the hand-held mode, the user can carry the connection assembly 100 in a narrow space for the near-ground mobile shooting, as can be seen in a combination mode in FIG. 1.

It can be understood that the multiple usage modes and/or the multiple usage attitudes of the gimbal 1000 can be other than those described above, and can include, for example, hand-held, shoulder-carried, on-board, vehicle-mounted, etc. (where the hand-held can also include single-handed, dual-handed). Explanation of the usage modes and/or the usage attitudes are not limited to type of carrier carrying the gimbal 1000, not limited to positional relationship between the gimbal 1000 and the carrier carrying the gimbal 1000, not limited to the attitude of the gimbal 1000 relative to the carrier carrying the gimbal 1000, and is not limited to function of another additional accessory attached to the gimbal 1000 (mounting position of the additional accessory is not limited).

Referring to FIG. 2 or 3, the connection member 110 includes the middle frame 10 and/or the support member 20. In some embodiments, one support member 20 can be regarded as one connection member 110, and number of the support members 20 may be multiple. When the connection assembly 100 includes multiple support members 20, structures of at least two of the multiple support members 20 may be different, or structures of the multiple support members 20 are all the same. In some other embodiments, when the number of the support members 20 is multiple, the structure of each support member 20 may be different, that is, one support member 20 may be one connection member 110. In some other embodiments, when the number of the support members 20 is multiple, the structures of at least two of the multiple support members 20 may be different, for example, type A support members 20 and type B support members 20 have different structures. If number of the type A support members 20 are multiple and/or number of the type B support members 20 are multiple, it can be understood that the multiple type A support members 20 are one connection member 110, and the multiple type B support members are one connection member 110, that is, in this case, all the support members 20 of the same structure type can be configured as one connection member 110, and number of the connection member 110 is obtained by division according to the structure type.

When the connection member 110 is the middle frame 10, the middle frame 10 can be directly connected to the gimbal 1000, and specifically, the middle frame 10 can be detachably mounted at the operation member 202. When the connection member 110 is the support member 20, the support member 20 can be directly connected to the gimbal 1000, and specifically, the support member 20 can be detachably mounted at the operation member 202. When the connection member 110 includes the middle frame 10 and the support member 20, it can be that the middle frame 10 can be detachably mounted at the operation member 202, and the support member 20 can be detachably mounted at the middle frame 10; or, the middle frame 10 can be detachably mounted at the operation member 202, and the support member 20 can also be detachably mounted at the operation member 202. In some other embodiments, the middle frame 10 and the operation member 202 can also be used as an integral structure, and the support member 20 can be detachably mounted at the middle frame 10.

Referring to FIG. 2, the middle frame 10 may include the frame 11 and the base 12, and the base 12 may be arranged at the frame 11. The frame 11 includes a frame top surface 14, a frame bottom surface 15, and the frame side surface 16. The frame top surface 14 is opposite to the frame bottom surface 15, the frame side surface 16 is connected to the frame top surface 14 and the frame bottom surface 15, and the base 12 can be arranged at the frame side surface 16. The frame 11 is provided with a mounting through hole 191 passing through the frame top surface 14 and the frame bottom surface 15. The connection assembly 100 can be connected to the operation member 202 of the gimbal 1000 through the mounting through hole 191, that is, the operation member 202 of the gimbal 1000 can be inserted through the mounting through hole 191 of the middle frame 10.

The frame side surface 16 may include a first side surface 160, a second side surface 161, and an inclined side surface 162. The first side surface 160 is opposite to the second side surface 161, the inclined side surface 162 may be directly or indirectly connected to the first side surface 160 and the second side surface 161, and the first side surface 160, the second side surface 161, and the inclined side surface 162 can all be connected to the frame top surface 14 and the frame bottom surface 15. The inclined side surface 162 forms a certain inclination angle with respect to the frame top surface 14 and/or the frame bottom surface 15, for example, the inclined side surface 162 is inclined so that the frame 11 exhibits a structure with a large top and a small bottom, that is, the frame top surface 14 is larger in size than the frame bottom surface 15. An angle a formed by the inclined side surface 162 and the frame bottom surface 15 may be 100° to 110°, and the angle a may be any one of 100°, 101°, 102°, 103°, 104°, 105°, 106°, 107°, 108°, 109°, 110°, or any angle between the two.

In some other embodiments, the first side surface 160 may also include the inclined side surface 162, that is, the first side surface 160 may also form a certain inclination angle with respect to the frame top surface 14 and/or the frame bottom surface 15, for example, the angle a formed by the inclined side surface 162 in the first side surface 160 and the frame bottom surface 15 may be 100° to 110°. In some other embodiments, the second side surface 161 may also include the inclined side surface 162, that is, the second side surface 161 may also form a certain inclination angle with respect to the frame top surface 14 and/or the frame bottom surface 15, for example, the angle a formed by the inclined side surface 162 in the second side surface 161 and the frame bottom surface 15 may be 100° to 110°. In some other embodiments, the first side surface 160 and the second side surface 161 may both include the inclined side surface 162, and the angle a formed by the inclined side surface 162 and the frame bottom surface 15 may be 100° to 110°. The inclination angle formed by the first side surface 160 with respect to the frame top surface 14 and/or the frame bottom surface 15 may be the same as or different from the inclination angle formed by the second side surface 161 with respect to the frame top surface 14 and/or the frame bottom surface 15.

The frame 11 may include a first frame 17 and a second frame 18 both having independent structures. Volumes of the first frame 17 and the second frame 18 can be equal or not equal, and outline sizes of the two can be equal or not equal. In some embodiments, the volumes of the first frame 17 and the second frame 18 are not equal. It can be understood that a top surface of the first frame 17 together with a top surface of the second frame 18 can be used as the frame top surface 14, and a bottom surface of the first frame 17 together with a bottom surface of the second frame 18 can be used as the frame bottom surface 15, and a side surface of the first frame 17 together with a side surface of the second frame 18 can be used as the frame side surface 16.

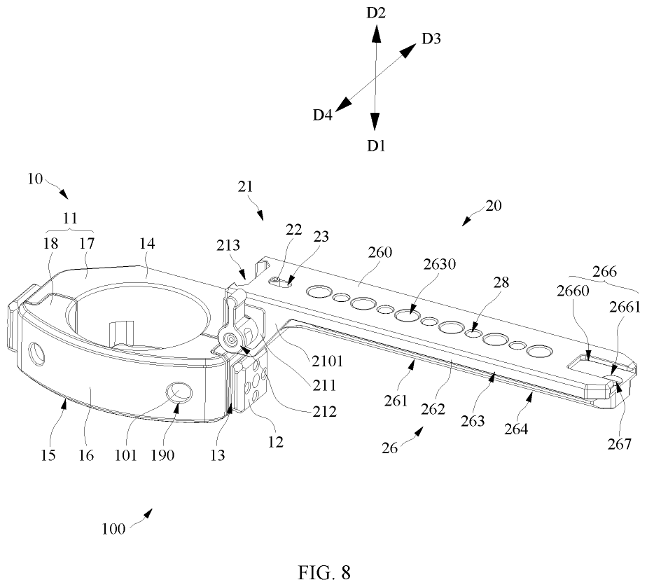

Referring to FIG. 8, the first frame 17 and the second frame 18 are detachably connected to each other to form the frame 11. For example, the frame side surface 16 is provided with a mounting hole 190 passing through the second frame 18 from the second frame 18 and extending into the first frame 17, and a fastener 101 can be mounted in the mounting hole 190 to connect the first frame 17 and the second frame 18. In addition, the first frame 17 and the second frame 18 cooperate to form the mounting through hole 191. Specifically, the first frame 17 is provided with a first mounting groove 176, and the second frame 18 is provided with a second mounting groove 180. After the first frame 17 and the second frame 18 are connected by the fastener 101, the first mounting groove 176 and the second mounting groove 180 jointly form the mounting through hole 191. Center of the mounting through hole 191 may be offset from center of the frame 11, and opening areas (or opening sizes) of the first mounting groove 176 and the second mounting groove 180 may be equal or not equal. In some embodiments, the first mounting groove 176 and the second mounting groove 180 have the same area and jointly form a circular mounting through hole 191. After the operation member 202 of the gimbal 1000 is inserted through the mounting through hole 191 of the middle frame 10, the middle frame 10 can rotate relative to the operation member 202, and can be fixed by the fastener 101 when the middle frame 10 rotates to a proper position relative to the operation member 202, so that relative position of the connection assembly 100 and the gimbal 1000 can be freely adjusted by the user according to actual shooting requirements and shooting environments.

Referring to FIG. 2 again, the first frame 17 includes a first frame body 170 and an extension wall 171, and the first mounting groove 176 is provided at the first frame body 170. Number of the extension walls 171 may be two. The two extension walls 171 are respectively arranged at opposite ends of the first mounting groove 176 (or the first frame body 170) and are both connected to the frame bottom surface 15 and the frame top surface 14. The two extension walls 171 and the first frame body 170 jointly enclose a mounting space 175. The volume of the second frame 18 may be smaller than the volume of the first frame 17, and the second frame 18 may be at least partially mounted within the mounting space 175.

Side surfaces of the first frame 17 include a first surface 172, a second surface 173, and an inclined surface 174 that are all connected to the bottom surface (or the frame bottom surface 15) and the top surface (or the frame top surface 14) of the first frame 17. The first surface 172 and the second surface 173 are respectively located at opposite sides of the first frame 17, or, the first surface 172 and the second surface 173 are respectively side surfaces of the extension wall 171 at opposite sides, or, the first surface 172 may be used as the first side surface 160, and the second surface 173 may be used as the second side surface 161. The inclined surface 174 may be directly or indirectly connected to the first surface 172 and the second surface 173, and the inclined surface 174 and the bottom surface of the first frame 17 are inclined to each other, or, the inclined surface 174 may also be used as the inclined side surface 162, that is, an angle a between the inclined surface 174 and the bottom surface of the first frame 17 may also be 100° to 110°.

The base 12 can be used to connect with the element to be mounted, so that the middle frame 10 and the element to be mounted can be connected. It should be noted that the element to be mounted may be the support member 20 (such as a case in which the support member 20 includes the side plate 26 as shown in FIG. 3 and/or a case in which the support member 20 includes the handle 27 as shown in FIG. 6), and the support member 20 can be detachably mounted at the base 12. The element to be mounted may also be another structure that is adapted to the base 12, for example, the element to be mounted may also be the photographing apparatus, a mobile phone, a follow focus, a flashlight, etc.

The base 12 can be fixed at any position at the frame side surface 16. For example, when number of the base 12 is one, the base 12 can be fixed at the first side surface 160 (or the first surface 172), or the base 12 can be fixed at the second side surface 161 (or the second surface 173), or the base 12 can be fixed at the inclined side surface 162 (or the inclined surface 174). In some other embodiments, the number of bases 12 may be multiple, and two of the multiple bases 12 are respectively formed at the first side surface 160 and the second side surface 161.

For example, the number of the bases 12 may be two, in which case, the two bases 12 may be respectively fixed at the first side surface 160 and the second side surface 161, or the two bases 12 may be respectively fixed at the first side surface 160 and the inclined side surface 162, or the two bases 12 may be respectively fixed at the second side surface 161 and the inclined side surface 162, or the two bases 12 may both be fixed at the inclined side surface 162. The number of the bases 12 may also be three. Two of the three bases 12 may be respectively fixed at the first side surface 160 and the second side surface 161, and the remaining base 12 may be fixed at the first side surface 160 or the second side surface 161 or the inclined side surface 162. The three bases 12 may also be respectively fixed at the first side surface 160, the second side surface 161, and the inclined side surface 162.

In some other embodiments, the number of the bases 12 may be multiple, in which case, the multiple bases 12 may be respectively arranged at the first frame body 170, at the extension wall 171, or at the first frame body 170 and the extension wall 171. In some embodiments, the number of the bases 12 are multiple, and the multiple bases 12 are spaced apart at the side surface of the first frame 17. More specifically, the number of the bases 12 is three, and the three bases 12 are respectively fixed at the first surface 172, the second surface 173, and the inclined surface 174. When the support member 20 (or the element to be mounted) is mounted at the base 12 at different positions of the frame side surface 16, such as in three situations when the support member 20 (or the element to be mounted) is mounted at the base 12 at the first side surface 160 (or the first surface 172), when the support member 20 (or the element to be mounted) is mounted at the base 12 at the second side surface 161 (or the second surface 173), and when the support member 20 (or the element to be mounted) is mounted at the base 12 at the inclined side surface 162 (or the inclined surface 174), etc., an angle a between the support member 20 (or the element to be mounted) and the vertical direction (equivalent to an extension direction of a axis of the mounting through hole 191) can change.

Referring to FIGS. 2 and 8, the base 12 includes a base body 120 and a protrusion 121. The base body 120 is fixed at the frame side surface 16, and the protrusion 121 protrudes from an edge of the base body 120 away from the frame side surface 16. The protrusion 121 may be spaced from the frame 11, so that the protrusion 121 cooperates with the frame side surface 16 to form a groove 13 having at least two sliding directions. As such, the support member 20 (or the element to be mounted) may be detachably mounted at the base 12 through the groove 13. In addition, the base body 120 may be provided with different shapes and structures so that the support member 20 (or the element to be mounted) can be mounted at the base 12 from different directions. For example, the base body 120 may have a rectangular block-shaped structure, and the support member 20 (or the element to be mounted) can be mounted at the base 12 from two opposite directions, or the base body 120 may have a square block-shaped structure, and the support member 20 (or the element to be mounted) can be mounted at the base 12 from four different directions (D1 to D4).

The base body 120 includes a base surface 122 away from the frame side surface 16, that is, the base surface 122 and the frame side surface 16 are located at opposite sides of the base body 120. The connection assembly 100 also includes a limiting structure 30 configured to restrict the support member 20 (or the element to be mounted) at the middle frame 10. The limiting structure 30 includes a receiving hole 124 provided at the base surface 122, and the receiving hole 124 can be configured to cooperate with the support member 20 (or the element to be mounted) to fix the support member 20 (or the element to be mounted) at the middle frame 10. Number of the receiving holes 124 may be multiple, and the multiple receiving holes 124 are spaced apart at the base surface 122. The multiple receiving holes 124 at different positions can adapt to the support member 20 (or the element to be mounted) being mounted at the base 12 from different directions, that is, the number of the receiving holes 124 is in one-to-one correspondence with number of directions in which the support member 20 (or the element to be mounted) is mounted at the base 12. The base surface 122 may also be provided with a first reserved mounting member 123, and the first reserved mounting member 123 is configured to mount a first reserved element that may be a shooting equipment such as a soft light, a reflector, a flashlight, a quartz lamp, a microphone, etc. or another device. In some embodiments, the first reserved mounting member 123 may be a first reserved hole 123 provided at the base surface 122. The first reserved hole 123 is spaced apart from the receiving hole 124, and specifically, one first reserved hole 133 may be surrounded by multiple receiving holes 124. In some other embodiments, the first reserved mounting member 123 may be a structure configured to mount and fix the first reserved element at the base 12 such as a snap structure, a threaded structure, etc.

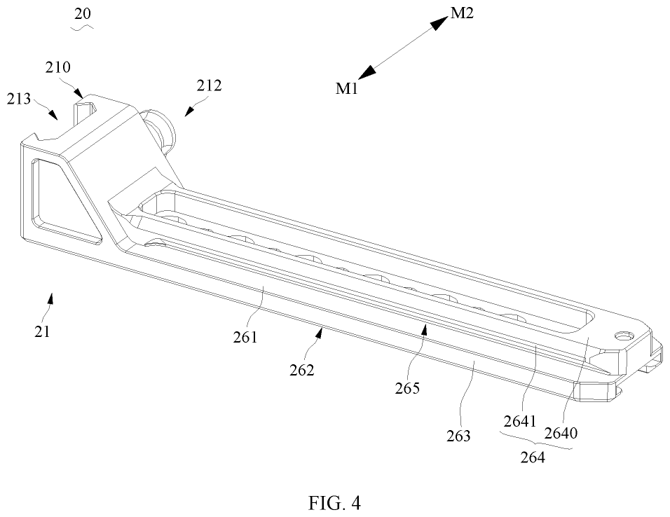

Referring to FIGS. 3 to 7, the support member 20 includes the mounting member 21, and the support member 20 can be detachably mounted at two or more than two different positions at the middle frame 10 or at an element to be assembled through the mounting member 21. It should be noted that the element to be assembled may be the middle frame 10, the gimbal 1000, the gimbal 1000 including the middle frame 10, or another structure adapted to the mounting member 21. Position at which the support member 20 can be detachably mounted at the middle frame 10 through the mounting member 21 depends on position at which the base 12 is arranged at the middle frame 10. As described above, the base 12 can be fixed at any position at the frame side surface 16, and the specific arrangement will not be repeated herein. Correspondingly, the support member 20 can also be detachably mounted at any position at the middle frame 10 through the mounting member 21. In addition, the mounting member 21 can be detachably mounted at the base 12 from at least two directions. The at least two directions may include two directions that are parallel or perpendicular to each other. The at least two directions may include three directions, where two of the three directions are arranged opposite to each other, or two of the three directions are arranged perpendicular to each other, or two of the three directions are arranged opposite to each other and two of the three directions are arranged perpendicular to each other. The at least two directions may include four directions, and the four directions include a first direction, a second direction, a third direction, and a fourth direction. The first direction and the second direction are arranged opposite to each other, and the third direction and the fourth direction are arranged opposite to each other and are both perpendicular to the first direction.

The mounting member 21 includes the fixed base 210, the movable member 211, and a locking structure 212. The fixed base 210 cooperates with the movable member 211 to form the accommodation groove 213, and the movable member 211 can move relative to the fixed base 210 to change the size of the accommodation groove 213. The locking structure 212 cooperates with the movable member 211 so that the mounting member 21 can be detachably mounted at the base 12 from at least two directions. When the mounting member 21 is mounted toward the base 12, the mounting member 21 of the support member 20 can move along the groove 13, and specifically, the mounting member 21 of the support member 20 can move along the protrusion 121. After the mounting member 21 of the support member 20 is mounted at the base 12, the base 12 is at least partially received in the accommodation groove 213.

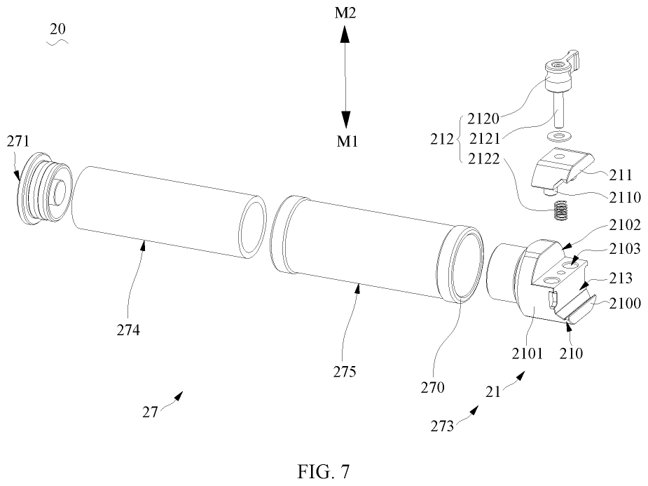

The fixed base 210 includes a fixed base end surface 2100 and a fixed base side surface 2101, and the fixed base end surface 2100 faces the base 12 after the mounting member 21 is mounted at the base 12. The accommodation groove 213 passes through the fixed base end surface end surface 2100 and the fixed base side surface 2101, and may be a dovetail groove structure. After the mounting member 21 of the support member 20 is mounted at the base 12, the protrusion 121 and the base body 120 are both received in the accommodation groove 213. One fixed base side surface 2101 is provided with a fixed base receiving groove 2102 passing through the fixed base end surface 2100 and communicating with the accommodation groove 213, and a positioning groove 2103 is provided at a side surface of the fixed base receiving groove 2102 (shown in FIG. 7). The movable member 211 is received in the fixed base receiving groove 2102, and a surface of the movable member 211 facing the positioning groove 2103 is provided with a positioning post 2110. The movable member 211 combines the positioning post 2110 with the positioning groove 2103, so that the movable member 211 can be movably received in the fixed base accommodation groove 2102. When the movable member 211 moves in the fixed base accommodation groove 2102, the movable member 211 can change the size of the accommodation groove 213.

Specifically, a direction in which the movable member 211 moves toward the fixed base 210 is a first movement direction M1 (shown in FIG. 3 or 6), and a direction in which the movable member 211 moves away from the fixed base 210 is a second movement direction M2, where the first movement direction M1 and the second movement direction M2 are two opposite directions. After the base 12 of the middle frame 10 (or the element to be assembled) is received in the accommodation groove 213, the size of the accommodation groove 213 is reduced along the first movement direction M1 when the movable member 211 moves in the first movement direction M1, that is, space size of the accommodation groove 213 is gradually reduced, so that a side surface of the movable member 211 and a side surface of the fixed base 210 abut against the base 12, and thereby the support member 20 is fixed at the base 12. The size of the accommodation groove 213 is increased along the second movement direction M2 when the movable member 211 moves in the second movement direction M2, that is, the space size of the accommodation groove 213 is gradually increased, in which case, the side surface of the movable member 211 and the side surface of the fixed base 210 are separated from the base 12, so that the support member 20 can be detached from the base 12, or slide to different positions at the base 12.

At least part of the locking structure 212 can be rotatably arranged within the support member 20, and specifically, the locking structure 212 can be rotatably arranged at the movable member 211 and the fixed base 210. The locking structure 212 can drive the movable member 211 to move relative to the fixed base 210 when the locking structure 212 rotates, so that distance between the movable member 211 and the fixed base 210 is reduced when the locking structure 212 is locked, and the distance between the movable member 211 and the fixed base 210 is increased when the locking structure 212 is released. The locking structure 212 includes a wrench 2120, a locking member 2121 and an elastic member 2122. The wrench 2120 is arranged on one side of the movable member 211 opposite to the fixed base 210, and the wrench 2120 is connected to the locking member 2121 and can drive the locking member 2121 to rotate. The locking member 2121 passes through the movable member 211, the elastic member 2122, and the fixed base 210, and can drive the movable member 211 to move relative to the fixed base 210 when the wrench 2120 drives the locking member 2121 to rotate. The locking member 2121 may be a screw. The elastic member 2122 is located near an end of the fixed base 210 and between the fixed base 210 and the movable member 211, and is always in a compressed state.

Specifically, after the base 12 of the middle frame 10 (or the element to be assembled) is received in the accommodation groove 213, the locking structure 212, the fixed base 210, and the movable member 211 cooperate with each other to fix or release the base 12. For example, when the locking structure 212 is locked, that is, when the wrench 2120 rotates and drives the locking member 2121 to rotate in a first rotation direction, the locking member 2121 drives the movable member 211 to move in the first movement direction M1, and the movable member 211 further compresses the elastic member 2122 and gradually approaches the fixed base 210, so that the size of the accommodation groove 213 is gradually reduced, and thereby the support member 20 is fixed at the base 12. When the locking structure 212 is released, that is, when the wrench 2120 rotates and drives the locking member 2121 to rotate in a second rotation direction, the locking member 2121 drives the movable member 211 to move in the second movement direction M2, and the locking member 2121 gradually retracts, so that compression of the elastic member 2122 is reduced, and the elastic member 2122 gradually restores its original length and applies a compression force on the movable member 211 in the second movement direction M2. The compression force compresses the movable member 211 when the size of the accommodation groove 213 is gradually increased, so that the support member 20 can be detached from the base 12, or slide to different positions at the base 12. The first rotation direction may be a clockwise rotation direction, and the second rotation direction may be a counterclockwise rotation direction. In some other embodiments, the first rotation direction and the second rotation direction may also be other directions, which are not limited herein.

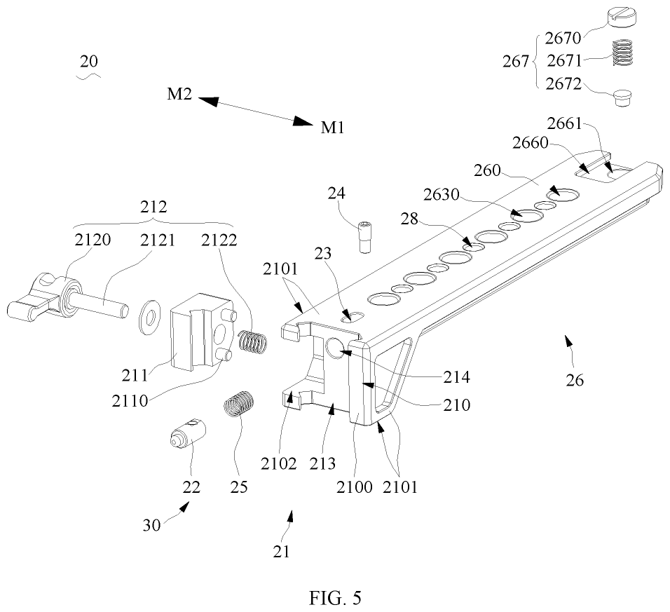

Referring to FIG. 5, when the support member 20 (or the element to be mounted) is mounted at the base 12 from different directions, the limiting structure 30 can restrict position of the support member 20 (or the element to be mounted) at the base 12 to avoid mounting misalignment between the support member 20 (or the element to be mounted) and the base 12. The limiting structure 30 also includes a limiting member 22, a shift level 24, and an elastic body 25 that are all arranged within the support member 20, and the limiting member 22 can stretch and retract. Specifically, a pin hole 214 is provided at a bottom surface of the accommodation groove 213. A sliding groove 23 is provided at the support member 20, and may be provided at the fixed base side surface 2101. The sliding groove 23 and the fixed base receiving groove 2102 may be provided at different fixed base side surfaces 2101, for example, the sliding groove 23 and the fixed base receiving groove 2102 may be respectively provided at adjacent fixed base side surfaces 2101. The sliding groove 23 communicates with the pin hole 214. The limiting member 22 may be a safety pin 22, which is arranged within the pin hole 214 and can move within the pin hole 214 to selectively extend into the accommodation groove 213 or be completely received within the pin hole 214. After the mounting member 21 is mounted at the base 12, the safety pin 22 extends into the receiving hole 124 to restrict movement of the support member 20 relative to the middle frame 10. When the mounting member 21 is detached from the base 12, the safety pin 22 extends out of the receiving hole 124 so that the support member 20 is out of restriction of the middle frame 10. When number of the receiving holes 124 is multiple, the safety pin 22 can extend into different receiving holes 124 to restrict the movement of the support member 20 relative to the middle frame 10 when the mounting member 21 is mounted at the base 12 from different directions. One end of the shift level 24 passes through the sliding groove 23 and is connected to the safety pin 22, and the other end of the shift lever 24 extends out of the sliding groove 23 from the support member 20, so that the shift lever 24 can slide in the sliding groove 23 to drive the safety pin 22 to selectively extend into the accommodation groove 213 or be completely received within the pin hole 214. The elastic body 25 can be arranged within the pin hole 214. The elastic body 25 is arranged at one side of the safety pin 22 away from the base 12, and can drive the safety pin 22 to move and extend into the receiving hole 124. The elastic body 25 can always be in a state providing an elastic force on the safety pin 22. The elastic force causes the safety pin 22 to extend into the accommodation groove 213, and also causes the shift lever 24 to be located at one end of the sliding groove 23 near the accommodation groove 213.

Specifically, when the support member 20 is mounted toward the base 12 of the middle frame 10 (or the element to be assembled) along one of the mounting directions, the mounting member 21 (or a side surface of the accommodation groove 213) can slide along the groove 13 of the base 12. The safety pin 22 retracts into the pin hole 214 under a compression force of the base surface 122 and is completely received within the pin hole 214, and correspondingly, the shift lever 24 also slides to one end of the sliding groove 23 away from the accommodation groove 213. When the safety pin 22 slides to a position in the receiving hole 124 corresponding to the mounting direction, the safety pin 22 is out of the compression force of the base surface 122, and the elastic body 25 drives the safety pin 22 to extend into the receiving hole 124 under an action of its own elastic force. At this time, the safety pin 22 restricts continued sliding of the support member 20, thereby avoiding the mounting misalignment between the support member 20 and the base 12.

When the user needs to disassemble the support member 20 from the middle frame 10 (or the element to be assembled), the user can move the shift lever 24 to the end of the sliding groove 23 away from the accommodation groove 213, and the shift lever 24 can drive the safety pin 22 to be separated from the receiving hole 124 and move to be completely received within the pin hole 214. At this time, the user can slide the mounting member 21 (or the side surface of the accommodation groove 213) along the groove 13 of the base 12 and gradually slide out of the base 12, so that the support member 20 and the middle frame 10 (or the element to be assembled) can be disassembled.

In some embodiments, the support member 20 may also include a second reserved mounting member 28. The second reserved mounting member 28 may be configured to mount a second reserved element that may be a shooting equipment such as a soft light, a reflector, a flashlight, a quartz lamp, a microphone, etc. or another device. In some other embodiments, the second reserved mounting member 28 may be a second reserved hole 28 provided at a surface of the support member 20, and the second reserved hole 28 may be a ⅛-inch threaded hole. Number of the second reserved holes 28 may be multiple, and the multiple second reserved holes 28 are spaced apart along a length extension direction of the support member 20. Further, sizes of two adjacent second reserved holes 28 among the multiple second reserved holes 28 may be different. In some other embodiments, the second reserved mounting member 28 may be a structure configured to mount and fix the second reserved element at the support member 20 such as a snap structure, a threaded structure, etc.

In some embodiments, the support member 20 may also include the side plate 26, or the support member 20 may also include the handle 27, or the support member 20 may also include the side plate 26 and the handle 27 at the same time.

When the support member 20 also includes the side plate 26, referring to FIGS. 3-5, the side plate 26 may be a plate structure, and the mounting member 21 may be located at one end of the side plate 26. The side plate 26 may also include a side plate body 263, a coupling block 264, a mounting structure 265, a coupling member 266, and a pressing member 267. One end of the side plate body 263 can be connected to the mounting member 21, and the other end of the side plate body 263 can be connected to the coupling member 266 and the pressing member 267. The side plate body 263 includes a side plate top surface 260, a side plate bottom surface 261, and a side plate side surface 262. The side plate top surface 260 and the side plate bottom surface 261 are arranged opposite to each other, and the side plate side surface 262 is connected to the side plate top surface 260 and the side plate bottom surface 261. The side plate body 263 is provided with a plurality of coupling holes 2630 that are spaced apart. The plurality of coupling holes 2630 pass through the side plate bottom surface 261 from the side plate top surface 260, and can be configured to mate with other shooting equipment (such as a soft light, a reflector, a flashlight, a quartz lamp, a microphone, etc.) or other equipment. The coupling hole 2630 may be a ¼-inch threaded hole. Number of the coupling holes 2630 may be multiple, and the multiple coupling holes 2630 are spaced apart along a length extension direction of the side plate body 263. It can be understood that the support member 20 may be provided with the coupling holes 2630 instead of the second reserved holes 28, and the support member 20 may also be provided with the second reserved holes 28 instead of the coupling holes 2630. The support member 20 may also be provided with the coupling holes 2630 and the second reserved holes 28 at the same time, and the coupling holes 2630 and the second reserved holes 28 are also arranged alternately and spaced apart, so that the coupling holes 2630 and the second reserved holes 28 can adapt to shooting equipment or other equipment with different apertures.

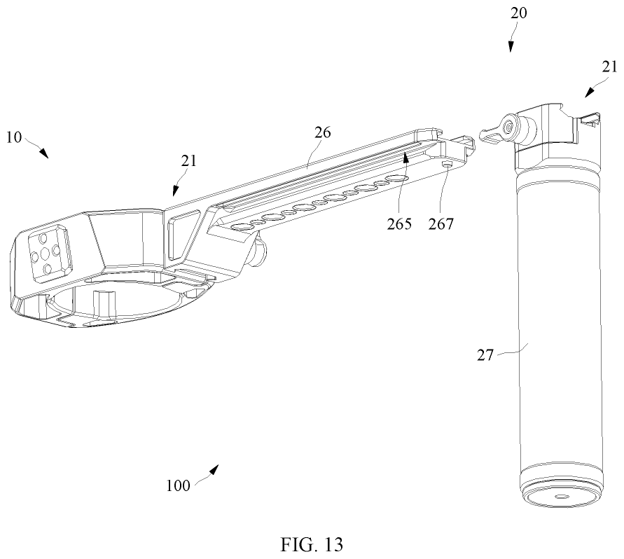

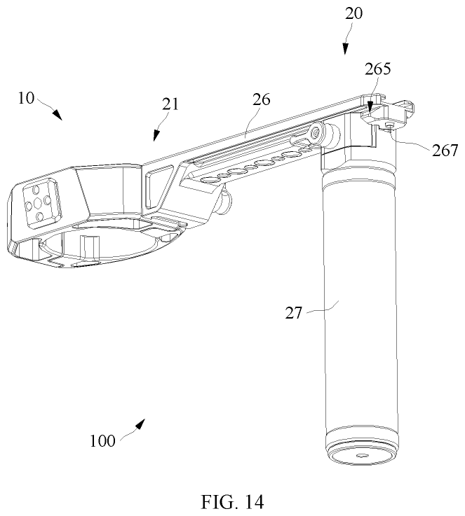

The coupling block 264 and the mounting structure 265 may be located at a bottom of the side plate body 263, and the coupling block 264 extends from the mounting member 21 toward the other end of the side plate body 263. The coupling block 264 includes a block body 2640 and a convex edge 2641. The block body 2640 is a ring-shaped structure surrounding the plurality of coupling holes 2630 and the plurality of second reserved holes 28, and the convex edge 2641 protrudes from an edge of an end of the block body 2640 away from the side plate body 263 toward a side away from the coupling hole 2630 and is spaced from the side plate body 263. The mounting structure 265 can be configured to mount the element to be mounted (or the support member 20) and/or pre-mount element, that is, when there are two or more support members 20, one of the support members 20 can be detachably mounted at another support member 20 through the mounting structure 265 (shown in FIGS. 13 and 14). The mounting structure 265 includes a mounting sliding groove 265 that may be formed by the convex edge 2641 and the side plate body 263 in spaced cooperation.

For example, when two support members 20 need to be coupled, the mounting member 21 of one support member 20 may be mounted at the mounting structure 265 of the other support member 20. Specifically, the mounting member 21 (or the side surface of the accommodation groove 213) of the support member 20 can slide in along the mounting sliding groove 265 of the other support member 20. The support member 20 can slide along the mounting sliding groove 265 of the other support member 20, and be fixed to any position at the mounting sliding groove 265 by the mounting member 21 of the support member 20. In some other embodiments, the mounting member 21 of the support member 20 may not have to slide in along the mounting sliding groove 265 of the other support member 20, that is, the mounting member 21 of the support member 20 can increase the size of the accommodation groove 213 as in the embodiments described above, so that the mounting member 21 of the support member 20 can be directly mounted at any position at the mounting sliding groove 265.

The coupling member 266 is provided with a coupling groove 2660 passing through the side plate top surface 260 and the side plate side surface 262. The coupling groove 2660 can be configured to mate with other shooting equipment (such as a soft light, a reflector, a flashlight, a quartz lamp, a microphone, etc.). A bottom surface of the coupling groove 2660 is also provided with a through hole 2661 that extends from a bottom of the coupling groove 2660 toward a direction of the coupling block 264 and passes through the coupling block 264.

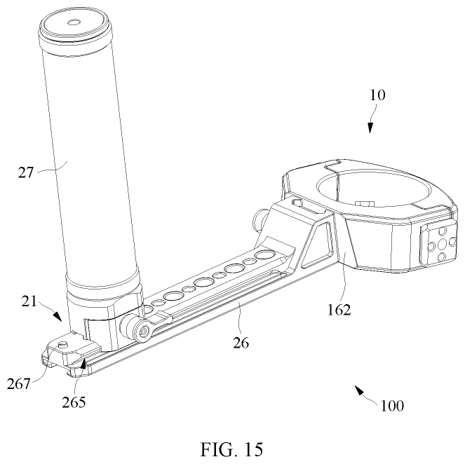

The pressing member 267 is arranged within the through hole 2661 and can move within the through hole 2661 to selectively extend out of the through hole 2661 from a side where the side plate bottom surface 261 is located or be received within the through hole 2661. The pressing member 267 includes a limiting head 2670, an elastic element 2671, and a pin body 2672. The limiting head 2670 and the elastic element 2671 are received within the through hole 2661. One end of the elastic element 2671 is connected to the limiting head 2670, and the other end abuts against the pin body 2672, so that a part of the pin body 2672 extends out of the through hole 2661. The limiting head 2670 can prevent the elastic element 2671 and the pin body 2672 from being completely separated from the through hole 2661. For example, when the mounting member 21 of one support member 20 slides in along the mounting sliding groove 265 of the other support member 20 and passes through the pressing member 267, the bottom surface of the accommodation groove 213 of the support member 20 generates a compression force on the pin body 2672 and causes the pin body 2672 to retract into the through hole 2661, so that the support member 20 smoothly slides into the mounting sliding groove 265 of the other support member 20. After the support member 20 slides over the pressing member 267, the pin body 2672 is out of the compression force of the bottom surface of the accommodation groove 213, and the elastic element 2671 drives the pin body 2672 to extend out of the through hole 2661 under an action of its own elastic force. At this time, the pressing member 267 prevents the support member 20 from sliding out of the other support member 20 along the length extension direction of the side plate body 263 (as can be seen in the connection modes in FIGS. 14 and 15), so that it can be avoided that, when the user adjusts the position of the support member 20 at the other support member 20, the two support members 20 may be separated from each other due to an excessive adjustment range.

When the support member 20 also includes the handle 27, referring to FIGS. 6 and 7, the handle 27 may be a cylindrical structure, and the mounting member 21 may be located at one end of the handle 27. The handle 27 includes a handle top surface 270, a handle bottom surface 271, and a handle side surface 272. The handle top surface 270 and the handle bottom surface 271 are arranged opposite to each other, and the handle side surface 272 is connected to the handle top surface 270 and the handle bottom surface 271. The mounting member 21 is arranged at the handle top surface 270, and the handle bottom surface 271 is provided with an opening 276.

The handle 27 may include a first handle body 273, a second handle body 274, and a handle sleeve 275. The mounting member 21 is arranged at the first handle body 273, and an external thread is formed at an end of the first handle body 273 away from the mounting member 21. The second handle body 274 has a cylindrical shape, and an internal thread is formed at one end of the second handle body 274. The first handle body 273 and the second handle body 274 can be detachably connected to each other through the external thread and the internal thread. The second handle body 274 is a hollow structure, so that the second handle body 274 of the hollow structure is not only conducive to reducing weight of the handle 27, but the user can also receive related accessories within the second handle body 274. The handle sleeve 275 is a ring structure, and can be detachably sleeved at the second handle body 274, so that the user can change different types of the handle sleeves 275 according to personal preference. In addition, the handle sleeve 275 can increase gripping friction force and facilitate gripping.

In a case where the gimbal 1000 is not provided with the bracket 300, the bracket 300 can be arranged in the connection assembly 100, and can be detachably mounted at the handle 27 through the opening 276 of the handle bottom surface 271. The bracket 300 may be a tripod, so that the bracket 300 can be used as a support structure of the connection assembly 100 to provide assistance for the shooting effect required by the user.

When the support member 20 also includes the side plate 26 and the handle 27 at the same time, the side plate 26 and the handle 27 can be respectively independent structures. The side plate 26 and the handle 27 are each provided with the mounting member 21 at one end. The specific structures of the side plate 26 and the handle 27 are the same as described above, and will not be repeated herein. There are various combination modes of the side plate 26, the handle 27, and the middle frame 10. That is, the mounting member 21 at the side plate 26 can be detachably mounted at the base 12 of the middle frame 10; the mounting member 21 at the handle 27 can be detachably mounted at the base 12 of the middle frame 10; the mounting member 21 can also be detachably mounted at the mounting structure 265 of the side plate 26; the mounting member 21 at one of the side plates 26 can be detachably mounted at the mounting structure 265 of the other side plate 26 when the number of the support members 20 having the side plates 26 is multiple.

The number of the support members 20 in the connection assembly 100 can be one, two, or more than two. For better description of the combination modes of the connection assembly 100, in a case where the support member 20 includes the side plate 26, the mounting member 21 of the support member 20 is referred to as the mounting member 21 at the side plate 26. Similarly, in a case where the support member 20 includes the handle 27, the mounting member 21 of the support member 20 is referred to as the mounting member 21 at the handle 27. The mounting member 21 at the side plate 26 can be detachably mounted at the base 12 of the middle frame 10; the mounting member 21 at the handle 27 can be detachably mounted at the base 12 of the middle frame 10; the mounting member 21 at the handle 27 can also be detachably mounted at the mounting structure 265 of the side plate 26. When the number of the support member 20 in the connection assembly 100 is one, the support member 20 may include the side plate 26 and the mounting member 21 at the side plate 26; or the support member 20 may include the handle 27 and the mounting member 21 at the handle 27. When the number of support members 20 in the connection assembly 100 is two, the support members 20 may include two side plates 26 and two mounting members 21 at the side plates 26, where the mounting member 21 at one of the side plates 26 can be detachably mounted at the mounting structure 265 of the other side plate 26; or the support member 20 may include one side plate 26, one mounting member 21 at the side plate 26, one handle 27, and one mounting member 21 at the handle 27, where the mounting member 21 at the handle 27 can be detachably mounted at the mounting structure 265 of the other side plate 26.

In a case where the connection assembly 100 includes the middle frame 10, the support member 20 may also include the side plate 26 and/or the handle 27, and there are various combination modes of the middle frame 10, the side plate 26, and/or the handle 27. In order to describe more clearly the various combination modes of the connection assembly 100, eight of them are listed below. In some other embodiments, the combination modes of the connection assembly 100 are not limited to the following eight modes, which will not be explained one by one herein.

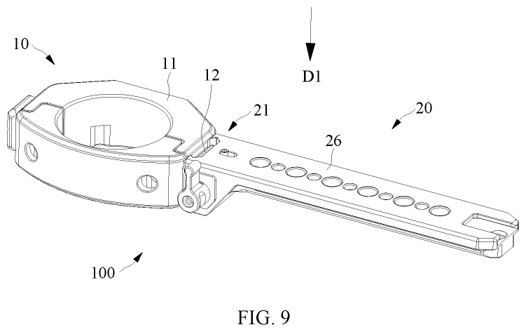

First combination: the number of the support member 20 is one, and the support member 20 includes the side plate 26. Reference may be made to FIGS. 9-12, and 19.

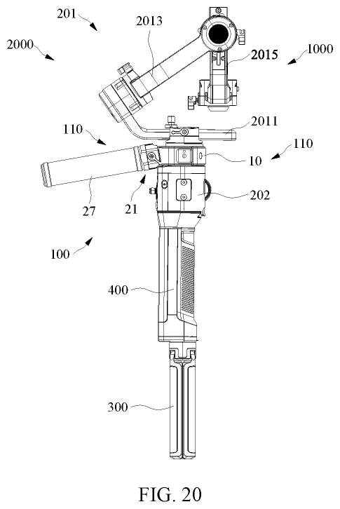

Second combination: the number of the support member 20 is one, and the support member 20 includes the handle 27. Reference may be made to FIG. 20.

Third combination: the number of the support members 20 is two, and both support members 20 include the side plates 26.

Fourth combination: the number of the support members 20 is two, one support member 20 includes the side plate 26, and the other support member 20 includes the handle 27. Reference may be made to FIGS. 14 and 15.

Fifth combination: the number of the support members 20 is three, and the three support members 20 each include the side plate 26. Two side plates 26 are connected to the middle frame 10, and the other side plate 26 is connected to any one of the side plates 26; length extension directions of the three side plates 26 are all different from length extension direction of the operation member 202 of the gimbal 1000, and the length extension directions of the two side plates 26 are the same.

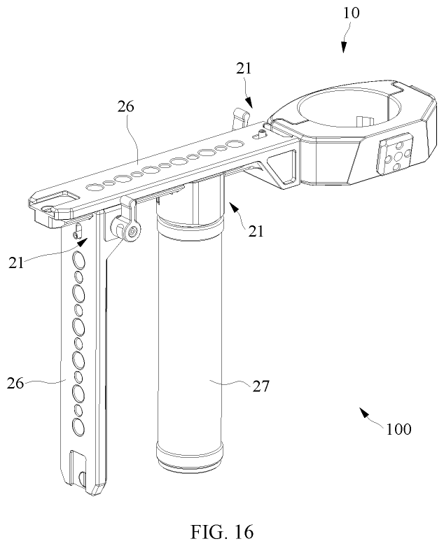

Sixth combination: the number of the support members 20 is three, two support members 20 each include the side plate 26, and the other support member 20 includes the handle 27. The two side plates 26 are connected to each other, and the handle 27 and one of the two side plates 26 are connected to each other; one side plate 26 is connected to the middle frame 10, and length extension directions of the other side plate 26, the handle 27, and the operation member 202 of gimbal 1000 are the same. Reference may be made to FIG. 16.

Seventh combination: the number of the support members 20 is three, one support member 20 includes the side plate 26, and two support members 20 each include the handle 27.

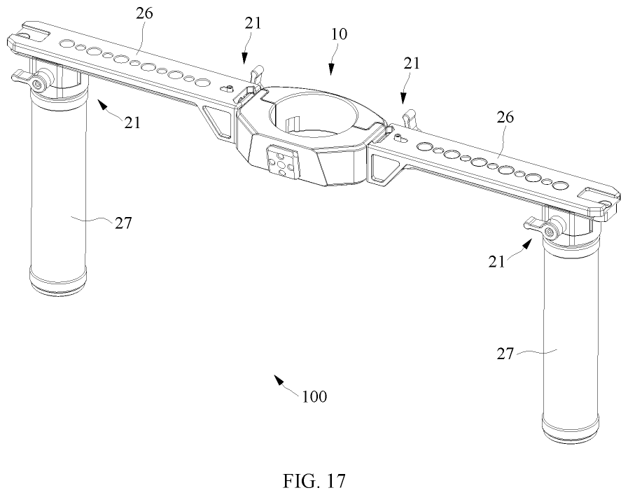

Eighth combination: the number of the support members 20 is four, two support members 20 each include the side plate 26, and the other two support members 20 each include the handle 27. Length extension directions of the two handles 27 are both the same as or opposite to the length extension direction of the operation member 202 of the gimbal 1000. Reference may be made to FIGS. 17, and 22-26.

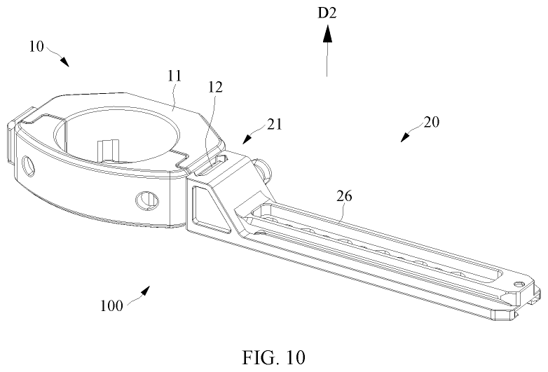

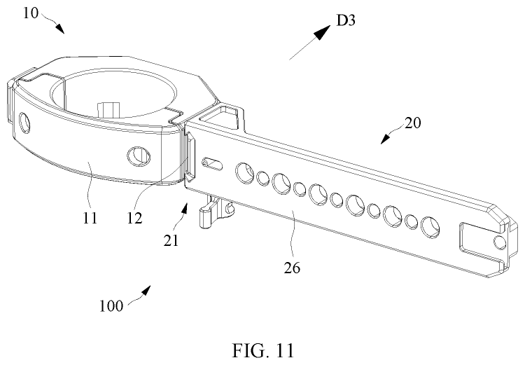

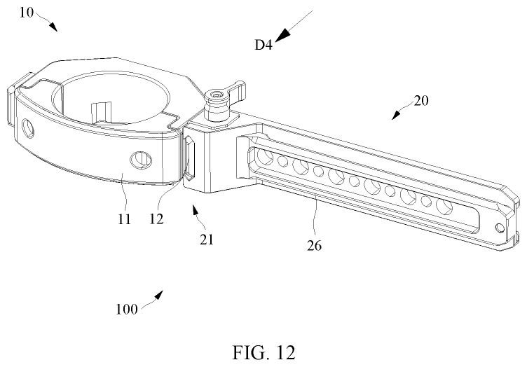

In the first combination, the mounting member 21 at the side plate 26 can be detachably mounted at the base 12 of the middle frame 10. Referring to FIG. 8, the mounting member 21 at the side plate 26 can be mounted at the base 12 of the middle frame 10 from four different directions. The four directions include a first direction D1, a second direction D2, a third direction D3, and a fourth direction D4, where the first direction D1 is opposite to the second direction D2, the third direction D3 is opposite to the fourth direction D4, the first direction D1 is perpendicular to both the third direction D3 and the fourth direction D4, and the second direction D2 is also perpendicular to both the third direction D3 and the fourth direction D4. The first direction D1 may be a mounting direction from one side of the frame top surface 14 of the middle frame 10 toward the base 12; the second direction D2 may be a mounting direction from one side of the frame bottom surface 15 of the middle frame 10 toward the base 12; the three directions D3 and the fourth direction D4 may be a mounting direction from one side of the frame side surface 16 of the middle frame 10 toward the base 12. As shown in FIG. 9, the mounting member 21 at the side plate 26 is mounted at the base 12 of the middle frame 10 from the first direction D1. As shown in FIG. 10, the mounting member 21 at the side plate 26 is mounted at the base 12 of the middle frame 10 from the second direction D2. As shown in FIG. 11, the mounting member 21 at the side plate 26 is mounted at the base 12 of the middle frame 10 from the third direction D3. As shown in FIG. 12, the mounting member 21 at the side plate 26 is mounted at the base 12 of the middle frame 10 from the fourth direction D4. In addition, the mounting member 21 at the side plate 26 can be mounted at the base 12 at different positions of the middle frame 10, where the mounting member 21 at the side plate 26 can be mounted at the base 12 located at the first side surface 160, the mounting member 21 at the side plate 26 can also be mounted at the base 12 located at the second side surface 161, and the mounting member 21 at the side plate 26 can also be mounted at the base 12 located at the inclined side surface 162. As such, the user can adjust different mounting positions and mounting directions according to actual conditions, which is beneficial to adapt to different shooting postures of the user. Also, when the mounting member 21 at the side plate 26 is mounted at the base 12 located at the inclined side surface 162, the side plate 26 is inclined in a direction away from the gimbal 1000, so that when length of the side plate 26 does not need to be made long, it is beneficial to form a certain avoidance space for the gimbal 1000 when the user holds the side plate 26, which can also prevent the handle from interfering with the gimbal 1000, or prevent the user from obstructing rotation of the gimbal 1000 with their hands. Moreover, since the mounting member 21 at the side plate 26 is mounted at the base 12 located at the inclined side surface 162, center of gravity of the connection assembly 100 is deviated, which is beneficial for the user to save effort when holding the side plate 26.

In the second combination, the mounting member 21 at the handle 27 can be detachably mounted at the base 12 of the middle frame 10. The mounting member 21 at the handle 27 can also be mounted at the base 12 of the middle frame 10 from four different directions, and the mounting member 21 at the handle 27 can also be mounted at the base 12 located at different positions at the frame side surface 16. For specific mounting directions and mounting positions, reference may be made to the first combination, that is, the connection assembly 100 in the second combination can include twelve connection modes.

First connection mode: the mounting member 21 at the handle 27 is mounted at the base 12 of the first side surface 160 of the middle frame 10 from the first direction D1.

Second connection mode: the mounting member 21 at the handle 27 is mounted at the base 12 of the first side surface 160 of the middle frame 10 from the second direction D2.

Third connection mode: the mounting member 21 at the handle 27 is mounted at the base 12 of the first side surface 160 of the middle frame 10 from the third direction D3.

Fourth connection mode: the mounting member 21 at the handle 27 is mounted at the base 12 of the first side surface 160 of the middle frame 10 from the fourth direction D4.

Fifth connection mode: the mounting member 21 at the handle 27 is mounted at the base 12 of the second side surface 161 of the middle frame 10 from the first direction D1.

Sixth connection mode: the mounting member 21 at the handle 27 is mounted at the base 12 of the second side surface 161 of the middle frame 10 from the second direction D2.

Seventh connection mode: the mounting member 21 at the handle 27 is mounted at the base 12 of the second side surface 161 of the middle frame 10 from the third direction D3.

Eighth connection mode: the mounting member 21 at the handle 27 is mounted at the base 12 of the second side surface 161 of the middle frame 10 from the fourth direction D4.

Nineth connection mode: the mounting member 21 at the handle 27 is mounted at the base 12 of the inclined side surface 162 of the middle frame 10 from the first direction D1.

Tenth connection mode: the mounting member 21 at the handle 27 is mounted at the base 12 of the inclined side surface 162 of the middle frame 10 from the second direction D2.

Eleventh connection mode: the mounting member 21 at the handle 27 is mounted at the base 12 of the inclined side surface 162 of the middle frame 10 from the third direction D3.

Twelfth connection mode: the mounting member 21 at the handle 27 is mounted at the base 12 of the inclined side surface 162 of the middle frame 10 from the fourth direction D4.

In the third combination, the mounting member 21 at one side plate 26 can be detachably mounted at the base 12 of the middle frame 10, and the mounting member 21 at the other side plate 26 can be detachably mounted at the mounting structure 265 of the side plate 26. For specific mounting directions and mounting positions, reference may be made to the first combination, that is, the connection assembly 100 in the third combination can include twelve connection modes. It can be understood that the connection modes of the connection assembly 100 in the third combination are not limited to the connection modes described below, which will not be explained one by one herein.

First connection mode: the mounting member 21 at one side plate 26 is mounted at the base 12 of the first side surface 160 of the middle frame 10 from the first direction D1, and the mounting member 21 at the other side plate 26 is mounted at the mounting structure 265 of the side plate 26.

Second connection mode: the mounting member 21 at one side plate 26 is mounted at the base 12 of the first side surface 160 of the middle frame 10 from the second direction D2, and the mounting member 21 at the other side plate 26 is mounted at the mounting structure 265 of the side plate 26.

Third connection mode: the mounting member 21 at one side plate 26 is mounted at the base 12 of the first side surface 160 of the middle frame 10 from the third direction D3, and the mounting member 21 at the other side plate 26 is mounted at the mounting structure 265 of the side plate 26.

Fourth connection mode: the mounting member 21 at one side plate 26 is mounted at the base 12 of the first side surface 160 of the middle frame 10 from the fourth direction D4, and the mounting member 21 at the other side plate 26 is mounted at the mounting structure 265 of the side plate 26.

Fifth connection mode: the mounting member 21 at one side plate 26 is mounted at the base 12 of the second side surface 161 of the middle frame 10 from the first direction D1, and the mounting member 21 at the other side plate 26 is mounted at the mounting structure 265 of the side plate 26.

Sixth connection mode: the mounting member 21 at one side plate 26 is mounted at the base 12 of the second side surface 161 of the middle frame 10 from the second direction D2, and the mounting member 21 at the other side plate 26 is mounted at the mounting structure 265 of the side plate 26.

Seventh connection mode: the mounting member 21 at one side plate 26 is mounted at the base 12 of the second side surface 161 of the middle frame 10 from the third direction D3, and the mounting member 21 at the other side plate 26 is mounted at the mounting structure 265 of the side plate 26.

Eighth connection mode: the mounting member 21 at one side plate 26 is mounted at the base 12 of the second side surface 161 of the middle frame 10 from the fourth direction D4, and the mounting member 21 at the other side plate 26 is mounted at the mounting structure 265 of the side plate 26.

Nineth connection mode: the mounting member 21 at one side plate 26 is mounted at the base 12 of the inclined side surface 162 of the middle frame 10 from the first direction D1, and the mounting member 21 at the other side plate 26 is mounted at the mounting structure 265 of the side plate 26.

Tenth connection mode: the mounting member 21 at one side plate 26 is mounted at the base 12 of the inclined side surface 162 of the middle frame 10 from the second direction D2, and the mounting member 21 at the other side plate 26 is mounted at the mounting structure 265 of the side plate 26.

Eleventh connection mode: the mounting member 21 at one side plate 26 is mounted at the base 12 of the inclined side surface 162 of the middle frame 10 from the third direction D3, and the mounting member 21 at the other side plate 26 is mounted at the mounting structure 265 of the side plate 26.

Twelfth connection mode: the mounting member 21 at one side plate 26 is mounted at the base 12 of the inclined side surface 162 of the middle frame 10 from the fourth direction D4, and the mounting member 21 at the other side plate 26 is mounted at the mounting structure 265 of the side plate 26.

In the fourth combination, the mounting member 21 at the side plate 26 can be detachably mounted at the base 12 of the middle frame 10, and the mounting member 21 at the handle 27 can be detachably mounted at the mounting structure 265 of the side plate 26. For specific mounting directions and mounting positions, reference may be made to the first combination, that is, the connection assembly 100 in the fourth combination can include twelve connection modes. It can be understood that the connection modes of the connection assembly 100 in the fourth combination are not limited to the connection modes described below, which will not be explained one by one herein.

First connection mode: the mounting member 21 at the side plate 26 is mounted at the base 12 of the first side surface 160 of the middle frame 10 from the first direction D1, and the mounting member 21 at the handle 27 is mounted at the mounting structure 265 of the side plate 26.

Second connection mode: the mounting member 21 at the side plate 26 is mounted at the base 12 of the first side surface 160 of the middle frame 10 from the second direction D2, and the mounting member 21 at the handle 27 is mounted at the mounting structure 265 of the side plate 26.

Third connection mode: the mounting member 21 at the side plate 26 is mounted at the base 12 of the first side surface 160 of the middle frame 10 from the third direction D3, and the mounting member 21 at the handle 27 is mounted at the mounting structure 265 of the side plate 26.

Fourth connection mode: the mounting member 21 at the side plate 26 is mounted at the base 12 of the first side surface 160 of the middle frame 10 from the fourth direction D4, and the mounting member 21 at the handle 27 is mounted at the mounting structure 265 of the side plate 26.

Fifth connection mode: the mounting member 21 at the side plate 26 is mounted at the base 12 of the second side surface 161 of the middle frame 10 from the first direction D1, and the mounting member 21 at the handle 27 is mounted at the mounting structure 265 of the side plate 26.

Sixth connection mode: the mounting member 21 at the side plate 26 is mounted at the base 12 of the second side surface 161 of the middle frame 10 from the second direction D2, and the mounting member 21 at the handle 27 is mounted at the mounting structure 265 of the side plate 26.

Seventh connection mode: the mounting member 21 at the side plate 26 is mounted at the base 12 of the second side surface 161 of the middle frame 10 from the third direction D3, and the mounting member 21 at the handle 27 is mounted at the mounting structure 265 of the side plate 26.

Eighth connection mode: the mounting member 21 at the side plate 26 is mounted at the base 12 of the second side surface 161 of the middle frame 10 from the fourth direction D4, and the mounting member 21 at the handle 27 is mounted at the mounting structure 265 of the side plate 26.

Nineth connection mode: the mounting member 21 at the side plate 26 is mounted at the base 12 of the inclined side surface 162 of the middle frame 10 from the first direction D1, and the mounting member 21 at the handle 27 is mounted at the mounting structure 265 of the side plate 26.

Tenth connection mode: the mounting member 21 at the side plate 26 is mounted at the base 12 of the inclined side surface 162 of the middle frame 10 from the second direction D2, and the mounting member 21 at the handle 27 is mounted at the mounting structure 265 of the side plate 26.

Eleventh connection mode: the mounting member 21 at the side plate 26 is mounted at the base 12 of the inclined side surface 162 of the middle frame 10 from the third direction D3, and the mounting member 21 at the handle 27 is mounted at the mounting structure 265 of the side plate 26.

Twelfth connection mode: the mounting member 21 at the side plate 26 is mounted at the base 12 of the inclined side surface 162 of the middle frame 10 from the fourth direction D4, and the mounting member 21 at the handle 27 is mounted at the mounting structure 265 of the side plate 26.

In the fifth combination, the mounting member 21 at one side plate 26 can be detachably mounted at the base 12 of the middle frame 10, and both the mounting members 21 at the other two side plates 26 can be detachably mounted at the mounting structure 265 of the side plate 26. Or, both the mounting members 21 at two side plates 26 can be detachably mounted at the base 12 of the middle frame 10, and the mounting members 21 at the third side plate 26 can be detachably mounted at the mounting structure 265 of any one of the side plates 26. For specific mounting directions and mounting positions, reference may be made to the first combination, that is, the connection assembly 100 in the fifth combination can include fourteen connection modes. It can be understood that the connection modes of the connection assembly 100 in the fifth combination are not limited to the connection modes described below, which will not be explained one by one herein.

First connection mode: the mounting member 21 at one side plate 26 is mounted at the base 12 of the first side surface 160 of the middle frame 10 from the first direction D1, and the mounting members 21 at the other two side plates 26 are respectively mounted at the mounting structure 265 of the side plate 26.

Second connection mode: the mounting member 21 at one side plate 26 is mounted at the base 12 of the first side surface 160 of the middle frame 10 from the second direction D2, and the mounting members 21 at the other two side plates 26 are respectively mounted at the mounting structure 265 of the side plate 26.

Third connection mode: the mounting member 21 at one side plate 26 is mounted at the base 12 of the first side surface 160 of the middle frame 10 from the third direction D3, and the mounting members 21 at the other two side plates 26 are respectively mounted at the mounting structure 265 of the side plate 26.

Fourth connection mode: the mounting member 21 at one side plate 26 is mounted at the base 12 of the first side surface 160 of the middle frame 10 from the fourth direction D4, and the mounting members 21 at the other two side plates 26 are respectively mounted at the mounting structure 265 of the side plate 26.

Fifth connection mode: the mounting member 21 at one side plate 26 is mounted at the base 12 of the second side surface 161 of the middle frame 10 from the first direction D1, and the mounting members 21 at the other two side plates 26 are respectively mounted at the mounting structure 265 of the side plate 26.

Sixth connection mode: the mounting member 21 at one side plate 26 is mounted at the base 12 of the second side surface 161 of the middle frame 10 from the second direction D2, and the mounting members 21 at the other two side plates 26 are respectively mounted at the mounting structure 265 of the side plate 26.

Seventh connection mode: the mounting member 21 at one side plate 26 is mounted at the base 12 of the second side surface 161 of the middle frame 10 from the third direction D3, and the mounting members 21 at the other two side plates 26 are respectively mounted at the mounting structure 265 of the side plate 26.

Eighth connection mode: the mounting member 21 at one side plate 26 is mounted at the base 12 of the second side surface 161 of the middle frame 10 from the fourth direction D4, and the mounting members 21 at the other two side plates 26 are respectively mounted at the mounting structure 265 of the side plate 26.

Nineth connection mode: the mounting member 21 at one side plate 26 is mounted at the base 12 of the inclined side surface 162 of the middle frame 10 from the first direction D1, and the mounting members 21 at the other two side plates 26 are respectively mounted at the mounting structure 265 of the side plate 26.

Tenth connection mode: the mounting member 21 at one side plate 26 is mounted at the base 12 of the inclined side surface 162 of the middle frame 10 from the second direction D2, and the mounting members 21 at the other two side plates 26 are respectively mounted at the mounting structure 265 of the side plate 26.

Eleventh connection mode: the mounting member 21 at one side plate 26 is mounted at the base 12 of the inclined side surface 162 of the middle frame 10 from the third direction D3, and the mounting members 21 at the other two side plates 26 are respectively mounted at the mounting structure 265 of the side plate 26.

Twelfth connection mode: the mounting member 21 at one side plate 26 is mounted at the base 12 of the inclined side surface 162 of the middle frame 10 from the fourth direction D4, and the mounting members 21 at the other two side plates 26 are respectively mounted at the mounting structure 265 of the side plate 26.

Thirteenth connection mode: the mounting member 21 at a first side plate 26 is mounted at the base 12 of the first side surface 160 of the middle frame 10 from the first direction D1, the mounting member 21 at a second side plate 26 is mounted at the base 12 of the inclined side surface 162 of the middle frame 10 from the first direction D1, and the mounting member 21 at a third side plate 26 is mounted at the mounting structure 265 of any one of the side plates 26 (the first side plate 26 or the second side plate 26). After the gimbal 1000 is connected in this connection mode, the user can carry the connection assembly 100 and the gimbal 1000 on shoulder, that is, after the middle frame 10 is mounted at the operation member 202 of the gimbal 1000, the user can carry the grip 400 on the shoulder, with one hand holding the first side plate 26, and the other hand holding the third side plate 26.

Fourteenth connection mode: the mounting member 21 at the first side plate 26 is mounted at the base 12 of the second side surface 161 of the middle frame 10 from the first direction D1, the mounting member 21 at the second side plate 26 is mounted at the base 12 of the inclined side surface 162 of the middle frame 10 from the first direction D1, and the mounting member 21 at the third side plate 26 is mounted at the mounting structure 265 of any one of the side plates 26 (the first side plate 26 or the second side plate 26). After the gimbal 1000 is connected in this connection mode, the user can carry the connection assembly 100 and the gimbal 1000 on shoulder, that is, after the middle frame 10 is mounted at the operation member 202 of the gimbal 1000, the user can carry the grip 400 on the shoulder, with one hand holding the first side plate 26, and the other hand holding the third side plate 26.

In the sixth combination, the mounting member 21 at one side plate 26 can be detachably mounted at the base 12 of the middle frame 10, the mounting member 21 at the other side plate 26 can be detachably mounted at the mounting structure 265 of the side plate 26, the mounting member 21 at the handle 27 can also be detachably mounted at the mounting structure 265 of the side plate 26. Or, the mounting member 21 at one side plate 26 can be detachably mounted at the base 12 of the middle frame 10, the mounting member 21 at the other side plate 26 can be detachably mounted at the mounting structure 265 of the side plate 26, and the mounting member 21 at the handle 27 can be detachably mounted at the other base 12 of the middle frame 10. For specific mounting directions and mounting positions, reference may be made to the first combination, that is, the connection assembly 100 in the sixth combination can include fourteen connection modes. It can be understood that the connection modes of the connection assembly 100 in the sixth combination are not limited to the connection modes described below, which will not be explained one by one herein.

First connection mode: the mounting member 21 at one side plate 26 is mounted at the base 12 of the first side surface 160 of the middle frame 10 from the first direction D1, the mounting member 21 at the other side plate 26 is mounted at the mounting structure 265 of the side plate 26, and the mounting member 21 at the handle 27 is also mounted at the mounting structure 265 of the side plate 26.

Second connection mode: the mounting member 21 at one side plate 26 is mounted at the base 12 of the first side surface 160 of the middle frame 10 from the second direction D2, the mounting member 21 at the other side plate 26 is mounted at the mounting structure 265 of the side plate 26, and the mounting member 21 at the handle 27 is also mounted at the mounting structure 265 of the side plate 26.

Third connection mode: the mounting member 21 at one side plate 26 is mounted at the base 12 of the first side surface 160 of the middle frame 10 from the third direction D3, the mounting member 21 at the other side plate 26 is mounted at the mounting structure 265 of the side plate 26, and the mounting member 21 at the handle 27 is also mounted at the mounting structure 265 of the side plate 26.

Fourth connection mode: the mounting member 21 at one side plate 26 is mounted at the base 12 of the first side surface 160 of the middle frame 10 from the fourth direction D4, the mounting member 21 at the other side plate 26 is mounted at the mounting structure 265 of the side plate 26, and the mounting member 21 at the handle 27 is also mounted at the mounting structure 265 of the side plate 26.

Fifth connection mode: the mounting member 21 at one side plate 26 is mounted at the base 12 of the second side surface 161 of the middle frame 10 from the first direction D1, the mounting member 21 at the other side plate 26 is mounted at the mounting structure 265 of the side plate 26, and the mounting member 21 at the handle 27 is also mounted at the mounting structure 265 of the side plate 26.

Sixth connection mode: the mounting member 21 at one side plate 26 is mounted at the base 12 of the second side surface 161 of the middle frame 10 from the second direction D2, the mounting member 21 at the other side plate 26 is mounted at the mounting structure 265 of the side plate 26, and the mounting member 21 at the handle 27 is also mounted at the mounting structure 265 of the side plate 26.

Seventh connection mode: the mounting member 21 at one side plate 26 is mounted at the base 12 of the second side surface 161 of the middle frame 10 from the third direction D3, the mounting member 21 at the other side plate 26 is mounted at the mounting structure 265 of the side plate 26, and the mounting member 21 at the handle 27 is also mounted at the mounting structure 265 of the side plate 26.

Eighth connection mode: the mounting member 21 at one side plate 26 is mounted at the base 12 of the second side surface 161 of the middle frame 10 from the fourth direction D4, the mounting member 21 at the other side plate 26 is mounted at the mounting structure 265 of the side plate 26, and the mounting member 21 at the handle 27 is also mounted at the mounting structure 265 of the side plate 26.

Nineth connection mode: the mounting member 21 at one side plate 26 is mounted at the base 12 of the inclined side surface 162 of the middle frame 10 from the first direction D1, the mounting member 21 at the other side plate 26 is mounted at the mounting structure 265 of the side plate 26, and the mounting member 21 at the handle 27 is also mounted at the mounting structure 265 of the side plate 26.

Tenth connection mode: the mounting member 21 at one side plate 26 is mounted at the base 12 of the inclined side surface 162 of the middle frame 10 from the second direction D2, the mounting member 21 at the other side plate 26 is mounted at the mounting structure 265 of the side plate 26, and the mounting member 21 at the handle 27 is also mounted at the mounting structure 265 of the side plate 26.

Eleventh connection mode: the mounting member 21 at one side plate 26 is mounted at the base 12 of the inclined side surface 162 of the middle frame 10 from the third direction D3, the mounting member 21 at the other side plate 26 is mounted at the mounting structure 265 of the side plate 26, and the mounting member 21 at the handle 27 is also mounted at the mounting structure 265 of the side plate 26.

Twelfth connection mode: the mounting member 21 at one side plate 26 is mounted at the base 12 of the inclined side surface 162 of the middle frame 10 from the fourth direction D4, the mounting member 21 at the other side plate 26 is mounted at the mounting structure 265 of the side plate 26, and the mounting member 21 at the handle 27 is also mounted at the mounting structure 265 of the side plate 26.

Thirteenth connection mode: the mounting member 21 at one side plate 26 is mounted at the base 12 of the first side surface 160 of the middle frame 10 from the first direction D1, the mounting member 21 at the other side plate 26 is mounted at the mounting structure 265 of the side plate 26, and the mounting member 21 at the handle 27 is mounted at the base 12 of the inclined side surface 162 of the middle frame 10 from the first direction D1.

Fourteenth connection mode: the mounting member 21 at one side plate 26 is mounted at the base 12 of the second side surface 161 of the middle frame 10 from the first direction D1, the mounting member 21 at the other side plate 26 is mounted at the mounting structure 265 of the side plate 26, and the mounting member 21 at the handle 27 is mounted at the base 12 of the inclined side surface 162 of the middle frame 10 from the first direction D1.

In the seventh combination, the mounting member 21 at the side plate 26 can be detachably mounted at the base 12 of the middle frame 10, the mounting member 21 at one handle 27 can be detachably mounted at the mounting structure 265 of the side plate 26, and the mounting member 21 at the other handle 27 can also be detachably mounted at the mounting structure 265 of the side plate 26. Or, the mounting member 21 at the side plate 26 can be detachably mounted at the base 12 of the middle frame 10, the mounting member 21 at one handle 27 can be detachably mounted at the mounting structure 265 of the side plate 26, and the mounting member 21 at the other handle 27 can be detachably mounted at the other base 12 of the middle frame 10. For specific mounting directions and mounting positions, reference may be made to the first combination, that is, the connection assembly 100 in the seventh combination can include fourteen connection modes. It can be understood that the connection modes of the connection assembly 100 in the seventh combination are not limited to the connection modes described below, which will not be explained one by one herein.

First connection mode: the mounting member 21 at the side plate 26 is mounted at the base 12 of the first side surface 160 of the middle frame 10 from the first direction D1, the mounting member 21 at the handle 27 is mounted at the mounting structure 265 of the side plate 26, and the mounting member 21 at the other handle 27 is also mounted at the mounting structure 265 of the side plate 26.

Second connection mode: the mounting member 21 at the side plate 26 is mounted at the base 12 of the first side surface 160 of the middle frame 10 from the second direction D2, the mounting member 21 at the handle 27 is mounted at the mounting structure 265 of the side plate 26, and the mounting member 21 at the other handle 27 is also mounted at the mounting structure 265 of the side plate 26.

Third connection mode: the mounting member 21 at the side plate 26 is mounted at the base 12 of the first side surface 160 of the middle frame 10 from the third direction D3, the mounting member 21 at the handle 27 is mounted at the mounting structure 265 of the side plate 26, and the mounting member 21 at the other handle 27 is also mounted at the mounting structure 265 of the side plate 26.

Fourth connection mode: the mounting member 21 at the side plate 26 is mounted at the base 12 of the first side surface 160 of the middle frame 10 from the fourth direction D4, the mounting member 21 at the handle 27 is mounted at the mounting structure 265 of the side plate 26, and the mounting member 21 at the other handle 27 is also mounted at the mounting structure 265 of the side plate 26.

Fifth connection mode: the mounting member 21 at the side plate 26 is mounted at the base 12 of the second side surface 161 of the middle frame 10 from the first direction D1, the mounting member 21 at the handle 27 is mounted at the mounting structure 265 of the side plate 26, and the mounting member 21 at the other handle 27 is also mounted at the mounting structure 265 of the side plate 26.

Sixth connection mode: the mounting member 21 at the side plate 26 is mounted at the base 12 of the second side surface 161 of the middle frame 10 from the second direction D2, the mounting member 21 at the handle 27 is mounted at the mounting structure 265 of the side plate 26, and the mounting member 21 at the other handle 27 is also mounted at the mounting structure 265 of the side plate 26.

Seventh connection mode: the mounting member 21 at the side plate 26 is mounted at the base 12 of the second side surface 161 of the middle frame 10 from the third direction D3, the mounting member 21 at the handle 27 is mounted at the mounting structure 265 of the side plate 26, and the mounting member 21 at the other handle 27 is also mounted at the mounting structure 265 of the side plate 26.

Eighth connection mode: the mounting member 21 at the side plate 26 is mounted at the base 12 of the second side surface 161 of the middle frame 10 from the fourth direction D4, the mounting member 21 at the handle 27 is mounted at the mounting structure 265 of the side plate 26, and the mounting member 21 at the other handle 27 is also mounted at the mounting structure 265 of the side plate 26.

Nineth connection mode: the mounting member 21 at the side plate 26 is mounted at the base 12 of the inclined side surface 162 of the middle frame 10 from the first direction D1, the mounting member 21 at the handle 27 is mounted at the mounting structure 265 of the side plate 26, and the mounting member 21 at the other handle 27 is also mounted at the mounting structure 265 of the side plate 26.

Tenth connection mode: the mounting member 21 at the side plate 26 is mounted at the base 12 of the inclined side surface 162 of the middle frame 10 from the second direction D2, the mounting member 21 at the handle 27 is mounted at the mounting structure 265 of the side plate 26, and the mounting member 21 at the other handle 27 is also mounted at the mounting structure 265 of the side plate 26.

Eleventh connection mode: the mounting member 21 at the side plate 26 is mounted at the base 12 of the inclined side surface 162 of the middle frame 10 from the third direction D3, the mounting member 21 at the handle 27 is mounted at the mounting structure 265 of the side plate 26, and the mounting member 21 at the other handle 27 is also mounted at the mounting structure 265 of the side plate 26.

Twelfth connection mode: the mounting member 21 at the side plate 26 is mounted at the base 12 of the inclined side surface 162 of the middle frame 10 from the fourth direction D4, the mounting member 21 at the handle 27 is mounted at the mounting structure 265 of the side plate 26, and the mounting member 21 at the other handle 27 is also mounted at the mounting structure 265 of the side plate 26.

Thirteenth connection mode: the mounting member 21 at the side plate 26 is mounted at the base 12 of the first side surface 160 of the middle frame 10 from the first direction D1, the mounting member 21 at the handle 27 is mounted at the mounting structure 265 of the side plate 26, and the mounting member 21 at the other handle 27 is mounted at the base 12 of the inclined side surface 162 of the middle frame 10 from the first direction D1.

Fourteenth connection mode: the mounting member 21 at the side plate 26 is mounted at the base 12 of the second side surface 161 of the middle frame 10 from the first direction D1, the mounting member 21 at the handle 27 is mounted at the mounting structure 265 of the side plate 26, and the mounting member 21 at the other handle 27 is mounted at the base 12 of the inclined side surface 162 of the middle frame 10 from the first direction D1.

In the eighth combination, the mounting members 21 at two side plates 26 can both be detachably mounted at the base 12 of the middle frame 10, and the mounting members 21 at two handles 27 can both be detachably mounted at the mounting member 21 at any one of the side plates 26. For specific mounting directions and mounting positions, reference may be made to the first combination, that is, the connection assembly 100 in the eighth combination can include eight connection modes. It can be understood that the connection modes of the connection assembly 100 in the eighth combination are not limited to the connection modes described below, which will not be explained one by one herein.

First connection mode: the mounting member 21 at one side plate 26 is mounted at the base 12 of the first side surface 160 of the middle frame 10 from the first direction D1, the mounting member 21 at the other side plate 26 is mounted at the base 12 of the second side surface 161 of the middle frame 10 from the first direction D1, the mounting member 21 at one handle 27 is mounted at the mounting structure 265 of the side plate 26, and the mounting member 21 at the other handle 27 is mounted at the mounting structure 265 of the other side plate 26.

Second connection mode: the mounting member 21 at one side plate 26 is mounted at the base 12 of the first side surface 160 of the middle frame 10 from the second direction D2, the mounting member 21 at the other side plate 26 is mounted at the base 12 of the second side surface 161 of the middle frame 10 from the first direction D1, the mounting member 21 at one handle 27 is mounted at the mounting structure 265 of the side plate 26, and the mounting member 21 at the other handle 27 is mounted at the mounting structure 265 of the other side plate 26.

Third connection mode: the mounting member 21 at one side plate 26 is mounted at the base 12 of the first side surface 160 of the middle frame 10 from the third direction D3, the mounting member 21 at the other side plate 26 is mounted at the base 12 of the second side surface 161 of the middle frame 10 from the first direction D1, the mounting member 21 at one handle 27 is mounted at the mounting structure 265 of the side plate 26, and the mounting member 21 at the other handle 27 is mounted at the mounting structure 265 of the other side plate 26.

Fourth connection mode: the mounting member 21 at one side plate 26 is mounted at the base 12 of the first side surface 160 of the middle frame 10 from the fourth direction D4, the mounting member 21 at the other side plate 26 is mounted at the base 12 of the second side surface 161 of the middle frame 10 from the first direction D1, the mounting member 21 at one handle 27 is mounted at the mounting structure 265 of the side plate 26, and the mounting member 21 at the other handle 27 is mounted at the mounting structure 265 of the other side plate 26.

Fifth connection mode: the mounting member 21 at one side plate 26 is mounted at the base 12 of the first side surface 160 of the middle frame 10 from the second direction D2, the mounting member 21 at the other side plate 26 is mounted at the base 12 of the second side surface 161 of the middle frame 10 from the fourth direction D4, the mounting member 21 at one handle 27 is mounted at the mounting structure 265 of the side plate 26, and the mounting member 21 at the other handle 27 is mounted at the mounting structure 265 of the other side plate 26.

Sixth connection mode: the mounting member 21 at one side plate 26 is mounted at the base 12 of the first side surface 160 of the middle frame 10 from the second direction D2, the mounting member 21 at the other side plate 26 is mounted at the base 12 of the second side surface 161 of the middle frame 10 from the second direction D2, the mounting member 21 at one handle 27 is mounted at the mounting structure 265 of the side plate 26, and the mounting member 21 at the other handle 27 is mounted at the mounting structure 265 of the other side plate 26.

Seventh connection mode: the mounting member 21 at one side plate 26 is mounted at the base 12 of the first side surface 160 of the middle frame 10 from the third direction D3, the mounting member 21 at the other side plate 26 is mounted at the base 12 of the second side surface 161 of the middle frame 10 from the third direction D3, the mounting member 21 at one handle 27 is mounted at the mounting structure 265 of the side plate 26, and the mounting member 21 at the other handle 27 is mounted at the mounting structure 265 of the other side plate 26.

Eighth connection mode: the mounting member 21 at one side plate 26 is mounted at the base 12 of the first side surface 160 of the middle frame 10 from the fourth direction D4, the mounting member 21 at the other side plate 26 is mounted at the base 12 of the second side surface 161 of the middle frame 10 from the fourth direction D4, the mounting member 21 at one handle 27 is mounted at the mounting structure 265 of the side plate 26, and the mounting member 21 at the other handle 27 is mounted at the mounting structure 265 of the other side plate 26.

In order to show the combination modes of the connection assembly 100 more clearly, some of the accompanying drawings in the specification will be further described in detail below.

In FIGS. 9-12, there are two connection members 110, one of which is the middle frame 10, and the other is the support member 20. The support member 20 (i.e., the side plate 26) is mounted at the middle frame 10 from different directions, so that the user can choose the appropriate mounting direction to connect the support member 20 and the middle frame 10 according to actual conditions, so as to combine into different connection modes to meet the shooting requirements and shooting environments of the user, such as adding accessories to the side plate 26 to enrich functions of the gimbal 1000, or taking the gimbal 1000 with one hand for shooting.

In FIG. 14, there are three connection members 110, of which one is the middle frame 10 and two are the support members 20. After the support member 20 (i.e., the side plate 26) is connected to the support member 20 (i.e., the handle 27), the support 20 (i.e., the side plate 26) is mounted at the base 12 of the second side surface 161 of the middle frame 10 from the first direction D1. After the gimbal 1000 is connected in this connection mode, the user can hold the support member 20 (i.e., the handle 27) with one hand so as to transversely shoot with the gimbal 1000, which is beneficial for the user to shoot and use in a low camera position. For example, the user can run and follow a target object while taking the connection assembly 100 and the gimbal 1000 with one hand. In some other embodiments, this connection mode can also realize dual-hand holding of the gimbal 1000 for shooting with using the grip 400 of the gimbal 1000.

In FIG. 15, there are three connection members 110, of which one is the middle frame 10 and two are the support members 20. After the support member 20 (i.e., the side plate 26) is connected to the support member 20 (i.e., the handle 27), the support 20 (i.e., the side plate 26) is mounted at the base 12 of the inclined side surface 162 of the middle frame 10 from the first direction D1. After the gimbal 1000 is connected in this connection mode, the user can hold the support member 20 (i.e., the handle 27) in position of the handle 27 with one hand so as to transversely shoot with the gimbal 1000, which is beneficial for the user to shoot and use in the low camera position. For example, the user can run and follow the target object while taking the connection assembly 100 and the gimbal 1000 with one hand. In addition, both the connection method of FIG. 15 and the connection method of FIG. 14 can be used as a single hand-held mode, and in the single hand-held mode of FIG. 15, the base 12 at the inclined side surface 162 causes the center of gravity of the connection assembly 100 to deviate, which is beneficial for the user to save effort when holding the handle 27.

In FIG. 16, there are four connection members 110, of which one is the middle frame 10 and three are the support members 20. After one support member 20 (i.e., the side plate 26) is mounted at the base 12 of the first side surface 160 of the middle frame 10 from the first direction D1, the other support member 20 (i.e., the side plate 26) and the support member 20 (i.e., the handle 27) are jointly mounted at the support member 20 (i.e., the side plate 26). After the gimbal 1000 is connected in this connection mode, the user can match it with a variety of shooting equipment, that is, after the middle frame 10 is mounted at the operation member 202 of the gimbal 1000, the user can hold the support member 20 (i.e., the handle 27) in the position of the handle 27 for shooting. When multiple shooting equipment needs to be matched at the same time, the user can mount the shooting equipment at the support member 20 (i.e., the side plate 26) and the other support member 20 (i.e., the side plate 26).

In FIG. 17, there are three connection members 110, of which one is the middle frame 10, one includes two side plates 26 forming one connection member 110, and the other includes two handles 27. After each side plate 26 is connected to each handle 27, the side plates 26 are respectively mounted at the bases 12 of the first side surface 160 and the second side surface 161 of the middle frame 10 from the first direction D1. After the gimbal 1000 is connected in this connection mode, the user can combine it as a dual hand-held form, and the user can hold the handles on two sides with two hands for use. The user can save more effort in this dual hand-held form, and when the user moves, a force applied by the user on the connection assembly 100 is more even, which is beneficial for the user to shoot more stably. In addition, this connection method can also be combined to be used as the single hand-held mode, and the user can hold the support member (i.e., the handle 27) at any side with one hand.

In FIG. 18, there is one connection member 110, and the connection member 110 is the middle frame 10. The middle frame 10 is mounted at the operation member 202 of the gimbal 1000. In this lightweight connection mode, the connection assembly 100 and the gimbal 1000 can be combined as a single hand-held form, and the user can perform a simple selfie in the single hand-held form. The user can also mount related shooting equipment at the middle frame 10 to use as an auxiliary form, which is beneficial for the user to obtain a better selfie effect.

In FIG. 19, the middle frame 10 is connected to the gimbal 1000, and the support member 20 (i.e., the side plate 26) is connected to the middle frame 10. In this connection mode, the connection assembly 100 and the gimbal 1000 can be combined to be used in the single hand-held mode, and the user can hold the support member 20 (i.e., the side plate 26) in position of the side plate 26 with one hand for use. The user can mount the related shooting equipment at the side plate 26 of the support member 20 (i.e., the side plate 26). In addition, this connection mode can also be combined as a shoulder-carried form, and the user can carry the connection assembly 100 and the gimbal 1000 on the shoulder, that is, the user can carry the grip 400 on the shoulder, and hold the support member 20 (i.e., the side plate 26) in the position of the side plate 26 with one hand. As such, the shoulder-carried connection mode is beneficial for the user in a case of a long shooting time, and a fatigue degree caused by the connection assembly 100 and the gimbal 1000 to the body of the user is not too great, which is beneficial for the body of the user to be more relaxed.

In FIG. 20, the middle frame 10 is connected to the gimbal 1000, and the support member 20 (i.e., the handle 27) is connected to the middle frame 10. In this connection mode, the connection assembly 100 and the gimbal 1000 can be combined to be used in the single hand-held mode, and the user can hold the support member 20 (i.e., the handle 27) with one hand for use. The difference between FIG. 20 and FIG. 19 is that the user can use the connection mode of FIG. 20 when the user does not need the assistance of other shooting equipment, and the user can use the connection mode of FIG. 19 when the user needs to match with other shooting equipment. In addition, this connection mode can also be combined as a shoulder-carrying form, and the user can carry the connection assembly 100 and the gimbal 1000 on the shoulder, that is, the user can carry the grip 400 on the shoulder, and hold the support member 20 (i.e., the handle 27) with one hand.

In FIG. 1, there are three connection members 110, of which one is the middle frame 10 and two are the support members 20. The middle frame 10 is mounted at the operation member 202 of gimbal 1000. One support member 20 (i.e., the side plate 26) is mounted at the base 12 of the inclined side surface 162 of the middle frame 10 from the first direction D1, and the other support member 20 (i.e., the handle 27) is mounted at the support member 20 (i.e., the side plate 26). In this connection mode, the connection assembly 100 and the gimbal 1000 can be combined to be used as the hand-held mode, and the user can hold the support member 20 (i.e., the handle 27) in the position of the handle 27 with one hand for use. The base 12 at the inclined side surface 162 causes the center of gravity of the connection assembly 100 to deviate, which is beneficial for the user to save effort when holding the handle 27.

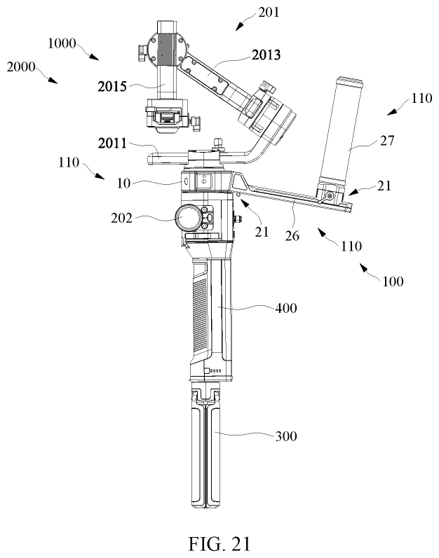

In FIG. 21, the connection assembly 100 is connected to the gimbal 1000 in the combination mode of FIG. 15. In this connection mode, the connection assembly 100 and the gimbal 1000 can be combined to be used as the single hand-held mode. The user can hold the support member 20 (i.e., the handle 27) in the position of the handle 27 with one hand so as to transversely shoot with the gimbal 1000, which is beneficial for the user to shoot and use in the low camera position. For example, the user can run and follow the target object while taking the connection assembly 100 and the gimbal 1000 with one hand. In addition, the base 12 at the inclined side surface 162 causes the center of gravity of the connection assembly 100 to deviate, which is beneficial for the user to save effort when holding the handle 27.

In FIG. 22, the connection assembly 100 is connected to the gimbal 1000 in the combination mode of FIG. 17. In this connection mode, the connection assembly 100 and the gimbal 1000 can be combined to be used in the upside-down mode (in some other embodiments, it can also be the portable suspension mode or the dual hand-held form), and the user can hold the support members 20 (including the handles 27) in the positions of the handles 27 at two sides with two hands for use. The user can save more effort in this dual hand-held form, and when the user moves, the force applied by the user on the connection assembly 100 is more even, which is beneficial for the user to shoot more stably. In addition, this connection method can also be combined to be used as the single hand-held mode, and the user can hold the support member (including the handle 27) in the position of the handle 27 at any side with one hand.

In FIG. 23, the middle frame 10 may be one connection member 110, the two side plates 26 may be one connection member 110, and the two handles may be one connection member 110. The middle frame 10 is mounted at the operation member 202 of the gimbal 1000, and after each side plate 26 is connected to each handle 27, the side plates 26 are mounted at the bases 12 of the first side surface 160 and the second side surface 161 of the middle frame 10 from the fourth direction D4. In this connection mode, the connection assembly 100 and the gimbal 1000 can be combined to be used in the portable suspension mode (in some other embodiments, it can also be the upside-down mode or the dual hand-held form), and the user can hold the support members 20 (i.e., the handles 27) in the positions of the handles 27 at two sides with two hands for use. In this case, the center of gravity of the connection assembly 100 and the gimbal 1000 is low, so that hands of the user are not overworked. In addition, this connection method can also be combined to be used as the single hand-held mode, and the user can hold the support member (including the handle 27) in the position of the handle 27 at any side with one hand.

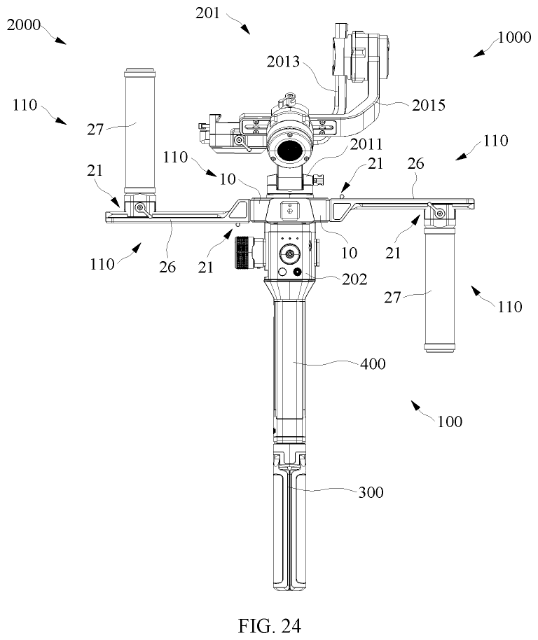

In FIG. 24, the middle frame 10 may be one connection member 110, the two side plates 26 may be one connection member 110, and the two handles may be one connection member 110. The middle frame 10 is mounted at the operation member 202 of the gimbal 1000, and after each side plate 26 is connected to each handle 27, the side plates 26 are mounted at the bases 12 of the first side surface 160 and the second side surface 161 of the middle frame 10 from the first direction D1 and the fourth direction D4, respectively. In this connection mode, the connection assembly 100 and the gimbal 1000 can be combined to be used in the portable suspension mode (or the dual hand-held form), and the user can hold the handles 27 at two sides with two hands for use. In addition, this connection method can also be combined to be used as the single hand-held mode, and the user can hold the support member (i.e., the handle 27) at any side with one hand.

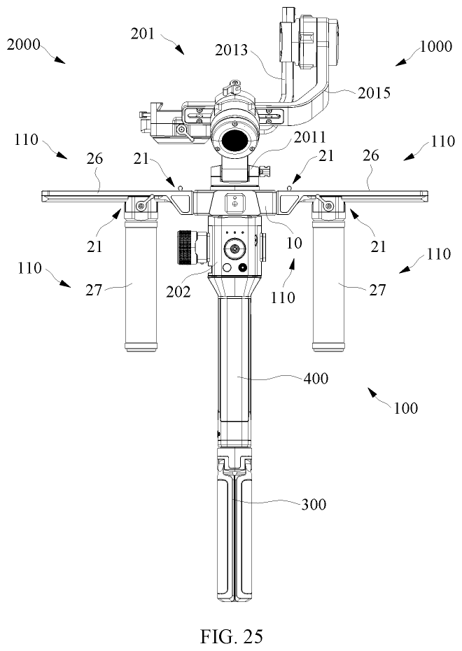

In FIG. 25, after the connection assembly 100 of FIG. 22 is connected to the gimbal 1000, the support member (i.e., the handle 27) can move at the support member (i.e., the side plate 26), and the user can move the support member (i.e., the handle 27) to a suitable position. Also, after the support member (i.e., the handle 27) is moved to a position close to the operation member 202, the user can also manipulate the operation member 202 while holding the handle 27.

In FIG. 26, after the connection assembly 100 of FIG. 22 is connected to the gimbal 1000, the grip 400 and the bracket 300 can be detached from the gimbal 1000 for use, so that space of the entire gimbal 1000 in longitudinal direction can be reduced, and operation of the user is more flexible.

According to embodiments of the present disclosure, the gimbal device 2000 and the connection assembly 100 can be detachably connected to each other by providing any two connection members 110, and there are multiple connection modes between the two connection members so as to support multiple usage modes of the gimbal 1000 and/or adapt to multiple usage attitudes of the gimbal 1000, which is beneficial to adapt to different shooting environments and provide assistance for shooting effect required by the user, so that application scenarios are diversified. According to embodiments of the present disclosure, the connection assembly 100 is also provided with the base 12 including multiple mounting directions, so that the element to be mounted can be mounted at the base 12 from different mounting directions according to actual conditions, which improves the adaptability of the base 12 and the element to be mounted. Therefore, the middle frame 10 and the element to be mounted can be combined into multiple usage attitudes, and usage scenarios of the connection assembly 100 can be enriched, so that the connection assembly 100 can be connected to the gimbal 1000 to form multiple usage modes and/or usage attitudes, which is conducive to diversification of the application scenarios. According to embodiments of the present disclosure, the connection assembly 100 is also provided with the support member 20 that can change the size of the accommodation groove 213, so that after the support member 20 is mounted at the gimbal 1000, the user can fix the support member 20 at the gimbal 1000 by reducing the size of the accommodation groove 213, and when the support member 20 and the gimbal 1000 need to be disassembled, the user can detach the support member 20 from the gimbal 1000 by increasing the size of the accommodation groove 213. As such, the support member 20 is simple in structure, and the operation of adjusting the size of the accommodation groove 213 is convenient, which are beneficial to reduce the complexity of the connection between the support member 20 and the gimbal 1000, and improve assembly and disassembly efficiency of the user. In addition, the accommodation grooves 213 of different sizes increase the selection of connection positions of the connection assembly 100 and the gimbal 1000, and the user can connect the connection assembly 100 to different positions at the gimbal 1000 according to actual shooting needs to be connected to the gimbal 1000 to form multiple usage attitudes, so that the application scenarios of the connection assembly 100 are diversified.

In the description of this specification, the description with reference to the terms “certain embodiments,” “an embodiment,” “some embodiments,” “exemplary embodiments,” “examples,” “specific examples,” or “some examples,” etc., means that combinations of the specific features, structures, materials, or characteristics described by the embodiments or the examples may be included in at least one embodiment or example of the present disclosure. In this specification, the schematic representations of the above terms do not necessarily refer to the same embodiment or example. Moreover, the described specific features, structures, materials, or characteristics can be combined in an appropriate manner in any one or more embodiments or examples.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “multiple” means at least two, such as two, three, etc., unless otherwise specifically defined.

Although the embodiments of the present disclosure have been shown and described above, it can be understood that the embodiments described above are exemplary and should not be construed as limitations to the present disclosure. Those of ordinary skill in the art can make changes, modifications, substitutions, and variants to the embodiments described above within the scope of the present disclosure.

1. A connection assembly comprising:
two connection members configured to be detachably connected to each other, at least one of the two connection members being configured to be connected to a gimbal;
wherein the two connection members are configured to be connected to each other in one of a plurality of connection modes to support a plurality of usage modes of the gimbal and/or adapt to a plurality of usage attitudes of the gimbal.

2. The connection assembly of claim 1, wherein the at least one of the two connection members is detachably mounted at an operation member of the gimbal.

3. The connection assembly of claim 1, wherein the two connection members include:
a middle frame configured to be mounted at the gimbal; and
a support member configured to be detachably mounted at the middle frame.

4. The connection assembly of claim 3, wherein:
the middle frame includes a frame and a base fixed at a frame side surface of the frame; and
the support member includes a mounting member configured to be detachably mounted to the base from at least two directions.

5. The connection assembly of claim 4, wherein:
the mounting member includes an accommodation groove, the base being at least partially received in the accommodation groove when the support member is mounted at the base; and
the middle frame includes a groove, the support member being configured to move along the groove when the mounting member is mounted toward the base, and the base being at least partially received in the accommodation groove after the mounting member is mounted at the base.

6. The connection assembly of claim 5, wherein:
the mounting member further includes a fixed base and a movable member, and the fixed base cooperates with the movable member to form the accommodation groove, the movable member being configured to move relative to the fixed base to change a size of the accommodation groove; and
the mounting member further includes a locking structure, the locking structure cooperating with the movable member to allow the mounting member to be detachably mounted to the base from at least two directions.

7. The connection assembly of claim 6, wherein:
the movable member is movably arranged at one side of the fixed base; and
the locking structure is rotatably arranged at the movable member and the fixed base, and is configured to drive the movable member to move relative to the fixed base when the locking structure rotates.

8. The connection assembly of claim 4, wherein the support member is configured to be detachably mounted at two or more different positions at the middle frame through the mounting member.

9. The connection assembly of claim 8, wherein:
the frame includes a frame top surface and a frame bottom surface opposite to each other, the frame side surface being connected to the frame top surface and the frame bottom surface;
the frame side surface includes a first side surface and a second side surface opposite to each other, each of the first side surface and the second side surface being connected to both the frame top surface and the frame bottom surface; and
the base is formed at the first side surface or the second side surface.

10. The connection assembly of claim 9, wherein:
the base is a first base;
an angle between the support member and a vertical direction changes in response to changing of a position of the middle frame at which the support member is mounted;
the frame side surface further includes an inclined side surface arranged between the first side surface and the second side surface, the inclined side surface and the frame bottom surface being inclined relative to each other; and
the middle frame further includes a second base formed at the inclined side surface.

11. The connection assembly of claim 4, wherein:
the frame includes a frame top surface and a frame bottom surface opposite to each other, the frame side surface being connected to the frame top surface and the frame bottom surface; and
the frame is provided with a mounting through hole passing through the frame top surface and the frame bottom surface and configured to mount the connection assembly at the gimbal.

12. The connection assembly of claim 11, wherein the frame includes a first frame and a second frame detachably connected to each other, the first frame and the second frame cooperating to form the mounting through hole.

13. The connection assembly of claim 3, wherein the support member further includes at least one of a side plate or a handle, the side plate being a plate structure, and the handle being a cylindrical structure.

14. The connection assembly of claim 13, wherein:
the support member includes:
the side plate that is connected to the middle frame through the mounting member; or
the handle that is connected to the middle frame through the mounting member; or
the support member is one of a plurality of support members, at least one of the plurality of support members being detachably mounted at the middle frame, wherein:
each of the plurality of support members is one of the connection members; or
two or more of the plurality of support members that are of a same structure type are configured as one of the connection members.

15. The connection assembly of claim 14, wherein:
the two connection members are configured to be detachably mounted to each other through the mounting member; and
one of the plurality of support members is configured to move relative to another one of the plurality of support members.

16. The connection assembly of claim 14, wherein the plurality of support members include the handle, the handle including a handle top surface, a handle bottom surface, and a handle side surface, the handle top surface and the handle bottom surface being arranged opposite to each other, the handle side surface being connected to the handle top surface and the handle bottom surface, and the mounting member being arranged at the handle top surface.

17. The connection assembly of claim 16,
wherein the handle bottom surface is located at one side of the handle away from the mounting member, and is provided with an opening;
the connection assembly further comprising:
a bracket configured to be detachably mounted at the handle through the opening.

18. The connection assembly of claim 3, wherein the support member is one of a plurality of support members that include:
two side plates connected to each other and a handle connected to one of the two side plates, a first one of the two side plates being connected to the middle frame, and length extension directions of a second one of the two side plates, the handle, and the operation member of gimbal are same; or
three side plates, two of the three side plates being connected to the middle frame, another of the three side plates being connected to one of the two of the three side plates, length extension directions of the three side plates being different from a length extension direction of the operation member of the gimbal, and the length extension directions of two of the three side plates are same; or
two side plates mounted at the middle frame and two handles mounted at the two side plates, respectively, the two handles forming one of the connection members.

19. The connection assembly of claim 3, wherein the support member is one of a plurality of support members that include:
two side plates oppositely arranged at the middle frame; and
two handles each having a length extension direction same as or opposite to a length extension direction of the operation member of the gimbal.

20. A gimbal device comprising:
a gimbal; and
a connection assembly including:
two connection members configured to be detachably connected to each other, at least one of the two connection members being configured to be connected to the gimbal;
wherein the two connection members are configured to be connected to each other in one of a plurality of connection modes to support a plurality of usage modes of the gimbal and/or adapt to a plurality of usage attitudes of the gimbal.
